(19) United States
(12) Patent Application Publication
(10) Pub. No.: US 2026/0176415 A1
(43) Pub. Date: Jun. 25, 2026

(54) Cyclic Polymers and Methods of Making Thereof

(71) Applicant: COLORADO STATE UNIVERSITY RESEARCH FOUNDATION, Fort Collins, CO (US)

(72) Inventors: Eugene CHEN, Fort Collins, CO (US); Li ZHOU, Fort Collins, CO (US)

(21) Appl. No.: 19/082,079

(22) Filed: Mar. 17, 2025

Related U.S. Application Data
(60) Provisional application No. 63/565,862, filed on Mar. 15, 2024.

(51) Int. Cl. C08G 63/08; C08G 63/87; C08G 75/26

(52) U.S. Cl. CPC C08G 63/08; C08G 63/87; C08G 75/26

(57) ABSTRACT

Described herein are cyclic polymers, including ultrahigh-molar-mass (UHMM, >2 million Da) cyclic polymers. These cyclic polymers can be prepared via catalyst-mediated (e.g., superbase-mediated) ring-opening polymerization followed by macromolecular cyclization triggered by protic quenching. This proton-triggered linear-to-cyclic topological transformation enables selective, linear-polymer-like access to desired cyclic polymers, including those with UHMM surpassing 2 MDa and/or possessing a dispersity (Ð) of 1.4 or less. In addition, these methods can eliminate the need for stringent conditions such as high dilution to prevent or suppress linear polymer contaminants. These cyclic polymers can exhibit not only much enhanced thermostability and mechanical toughness, and can also be quantitatively recycled back to monomer under mild conditions.

### CROSS-REFERENCE TO RELATED APPLICATIONS

This application claims benefit of priority of U.S. Provisional Application No. 63/565,862, filed Mar. 15, 2024, which is incorporated herein by reference in its entirety.

### STATEMENT REGARDING FEDERALLY SPONSORED RESEARCH OR DEVELOPMENT

This invention was made with government support under grant DE-AC36-08GO28308 awarded by the Department of Energy. The government has certain rights in the invention.

### BACKGROUND

Cyclic polymers have continued to attract much attention in polymer science due to their unique loop topology and still unmet synthetic challenges in preparing them in high molar mass and purity, and in a controlled fashion. Without chain ends, cyclic polymers exhibit unique physical, rheological, and thermal properties relative to their linear counterparts. Notable progress has been made to understand cyclic polymers' topologically enabled properties, revealing their unique applications in biomedicine, microelectronics, and material science. The cyclic structure is traditionally accessed through ring closing or ring expansion mechanisms. The former approach typically requires high dilution or is otherwise plagued by the lack of control over molar mass and dispersity. The latter method requires specific catalysts or initiating species, and such suitable catalysts have been reported and successfully employed in ring-opening olefin metathesis and Lewis pair polymerization.

While some methods of forming cyclic polymers have been explored, existing methods generally produce polymers which are contaminated by linear polymers and/or exhibit high dispersity in molecular weight. Improved methods of forming cyclic polymers, in particular cyclic polymers with high molecular weight, low dispersity, and/or high purity are needed.

### SUMMARY

Disclosed herein are cyclic polymers defined by Formula I below

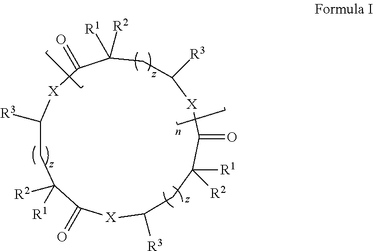

wherein R¹ and R² are individually hydrogen, C1-C12 alkyl, C2-C12 alkenyl, C2-C12 alkynyl, aryl, or heteroaryl, or R¹ and R² together with the atom to which they are attached form a cycloalkyl ring; R³ is hydrogen, C1-C12 alkyl, C2-C12 alkenyl, C2-C12 alkynyl, aryl, or heteroaryl; X is selected from O, S, and NR^{A}, wherein R^{A} is H or C1-C12 alkyl; z is an integer from 0 to 16; and n is an integer from 10 to 500,000.

In some embodiments, the polymer comprises an ultrahigh-molar-mass polymer having a number average molecular weight of at least 2 MDa.

In some embodiments, the polymer exhibits a dispersity (Ð) of 1.4 or less, such as a dispersity of from greater than 1 to 1.4, from 1.1 to 1.4, from 1.2 to 1.4, from greater than 1 to 1.3, from 1.1 to 1.3, from 1.2 to 1.3, from greater that 1 to 1.2, from 1.1 to 1.2, or from greater than 1 to 1.1.

In some embodiments, R¹ and R² are methyl, ethyl, propyl, or butyl. In some embodiments, R³ is hydrogen, methyl, ethyl, propyl, or butyl. In certain embodiments, R¹ and R² are methyl, ethyl, propyl, or butyl and R³ is hydrogen, methyl, ethyl, propyl, or butyl.

In some embodiments, z is 0, 1 or 2.

In some embodiments, n is an integer from 100 to 500,000, from 100 to 100,000, from 1,000 to 500,000, from 1,000 to 100,000, from 5,000 to 500,000, or from 5,000 to 100,000.

In some embodiments, the polymer comprises a cyclic block copolymer (e.g., a cyclic diblock copolymer or a cyclic triblock copolymer). In certain embodiments, the polymer comprises a cyclic block copolymer defined by Formula II below

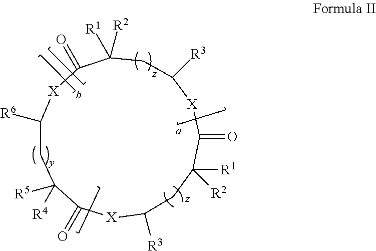

wherein X is selected from O, S, and NR^{A}, wherein R^{A} is H or C1-C12 alkyl; R¹ and R² are individually hydrogen, C1-C12 alkyl, C2-C12 alkenyl, C2-C12 alkynyl, aryl, or heteroaryl, or R¹ and R² together with the atom to which they are attached form a cycloalkyl ring; R³ is hydrogen, C1-C12 alkyl, C2-C12 alkenyl, C2-C12 alkynyl, aryl, or heteroaryl; R⁴ and R⁵ are individually hydrogen, C1-C12 alkyl, C2-C12 alkenyl, C2-C12 alkynyl, aryl, or heteroaryl, or R⁴ and R⁵ together with the atom to which they are attached form a cycloalkyl ring; R⁶ is hydrogen, C1-C12 alkyl, C2-C12 alkenyl, C2-C12 alkynyl, aryl, or heteroaryl; X is selected from O, S, and NR^{A}, wherein R^{A} is H or C1-C12 alkyl; y is an integer from 0 to 16; z is an integer from 0 to 16; and a is an integer from 5 to 490,000 and b is an integer from 5 to 490,000, wherein the sum of a and b is from 10 to 500,000; wherein the structure of the repeating units represented by x and y of Formula II are different.

In some embodiments, R¹, R², R⁴, and R⁵ are methyl, ethyl, propyl, or butyl. In some embodiments, R³ and R⁶ are hydrogen, methyl, ethyl, propyl, or butyl. In certain embodiments, R¹, R², R⁴, and R⁵ are methyl, ethyl, propyl, or butyl and R³ and R⁶ are hydrogen, methyl, ethyl, propyl, or butyl.

In some embodiments, y is 0, 1 or 2 and z is 0, 1, or 2.

Also provided herein are methods for preparing cyclic polymers. These methods can comprise ring opening polymerization (ROP) of a monomer of Formula III

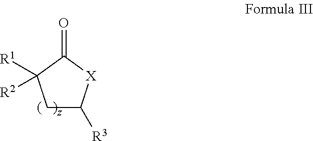

wherein R¹ and R² are individually hydrogen, C1-C12 alkyl, C2-C12 alkenyl, C2-C12 alkynyl, aryl, or heteroaryl, or R¹ and R² together with the atom to which they are attached form a cycloalkyl ring; R³ is hydrogen, C1-C12 alkyl, C2-C12 alkenyl, C2-C12 alkynyl, aryl, or heteroaryl; X is selected from O, S, and NR^{A}, wherein R^{A} is H or C1-C12 alkyl; and z is an integer from 0 to 16; wherein ROP comprises contacting the monomer of Formula III with a catalyst to form a linear ROP product; and protic quenching the linear ROP product.

In some embodiments, the monomer of Formula III comprises one of the following:

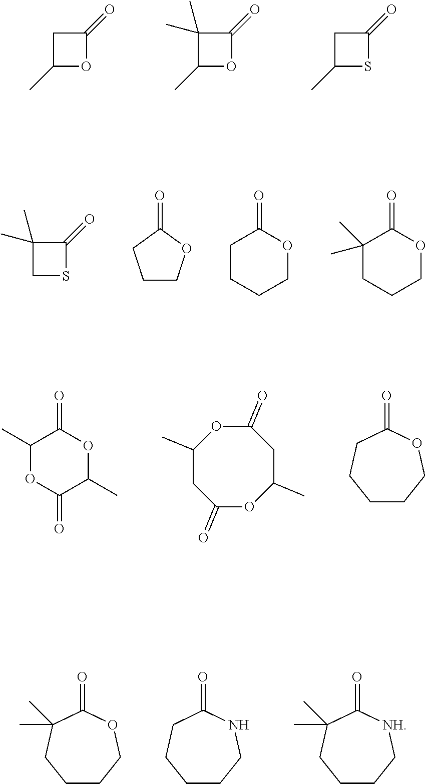

The catalyst can comprise a sterically bulky base. In some embodiments, the catalyst comprises a superbase. In some embodiments, the catalyst comprises a phosphazene.

In some embodiments, the catalyst comprises one of the following:

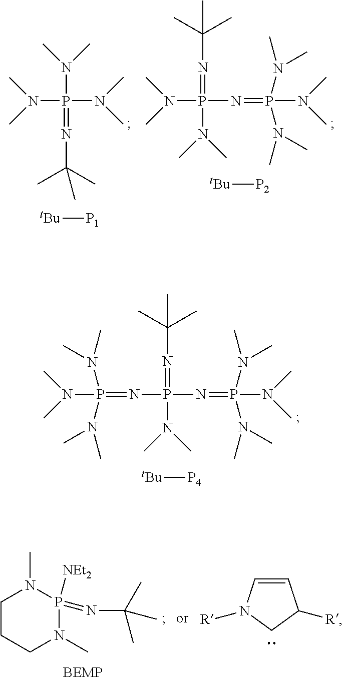

where R′ is alkyl or aryl.

In certain embodiments, the catalyst comprises 1-tert-butyl-4,4,4-tris(dimethylamino)-2,2-bis[tris(dimethylamino)-phosphoranylideneamino]-2λ⁵,4λ⁵-catenadi(phosphazene) (^{t}Bu-P₄).

Protic quenching can catalyze cyclization of the linear ROP product, thereby forming the cyclic polymer. Protic quenching can comprise contacting the linear ROP product with protic solvent, such as an alcohol or an acidified alcohol.

In some embodiments, protic quenching is performed after all of the monomer of Formula III has been polymerized.

In some embodiments, the method is performed as a one-pot process.

Also provided herein are methods for depolymerizing the cyclic polymers described herein. These methods can comprise contacting the cyclic polymer with a base, wherein the cyclic polymer is depolymerized to its constituent monomer and conversion to the constituent monomer is 20 wt. % or more.

In some embodiments, the constituent monomer can comprise a monomer defined by Formula III

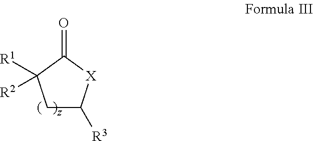

wherein R¹ and R² are individually hydrogen, C1-C12 alkyl, C2-C12 alkenyl, C2-C12 alkynyl, aryl, or heteroaryl, or R¹ and R² together with the atom to which they are attached form a cycloalkyl ring; R³ is hydrogen, C1-C12 alkyl, C2-C12 alkenyl, C2-C12 alkynyl, aryl, or heteroaryl; X is selected from O, S, and NR^{A}, wherein R^{A} is H or C1-C12 alkyl; and z is an integer from 0 to 16.

In some embodiments, the constituent monomer can comprise a monomer defined by Formula IV

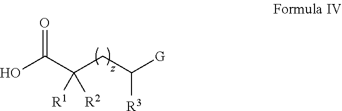

wherein R¹ and R² are individually hydrogen, C1-C12 alkyl, C2-C12 alkenyl, C2-C12 alkynyl, aryl, or heteroaryl, or R¹ and R² together with the atom to which they are attached form a cycloalkyl ring; R³ is hydrogen, C1-C12 alkyl, C2-C12 alkenyl, C2-C12 alkynyl, aryl, or heteroaryl; G is selected from OH, SH, and NHR^{A}, wherein R^{A} is H or C1-C12 alkyl; and z is an integer from 0 to 16.

### DESCRIPTION OF DRAWINGS

FIGS. 1A-1C. Illustration of proton-triggered cyclization vs. in-polymerization cyclization. FIG. 1A outlines common challenges in the synthesis of cyclic polymers due to competing linear chain propagation (orange arrow) and cyclization (purple arrow) processes leading to structural heterogeneity (purple rings and orange open chains). FIG. 1B shows chemically circular cyclic P3T(Me)₂P obtained through ^{t}Bu-P₄-mediated ROP and protic quenching, as well as catalyzed recycling to monomer with NaOH. FIG. 1C shows two proposed competing mechanisms (ring opening via nucleophilic attack at the carbonyl carbon or at the alkyl carbon) for macromolecular cyclization triggered by a protic reagent MeOH (shown in red color). The structure of the leaving group [P₄H]⁺ is enclosed in a box with a dashed border.

FIGS. 2A-2D. Evidences for the controlled synthesis l- and c-P3T(Me)₂P. FIG. 2A shows a plot of Mₙ and Ð values of c-P3T(Me)₂P as a function of the [(Me)₂TPL]:[^{t}Bu-P₄] ratio; Mₙ is shown in black and Ð in blue. FIG. 2B shows SEC curves for the c-P3T(Me)₂P samples produced at the different [(Me)₂TPL]:[^{t}Bu-P₄] ratio. FIG. 2C shows a MALDI-TOF MS spectrum of c-P3T(Me)₂P produced with [(Me)₂TPL]:[^{t}Bu-P₄]=50:1; the inset is the plot of m/z values vs the number of (Me)₂TPL repeat units. The series of molecular ion peaks are assigned to the c-P3T(Me)₂P without no chain ends [M_{end}=0+23 (Na⁺) g/mol]. FIG. 2D shows a MALDI-TOF MS spectrum of l-P3T(Me)₂P produced with [(Me)₂TPL]:[DBU]:[BnSH]=50:1:1; * denotes “× or times”.

FIGS. 3A-3I. Comparative characterizations of linear (orange lines) and cyclic (purple lines) P3T(Me)₂P prepared by different quenching methods. FIG. 3A shows that different quenching methods yield different topologies through end-group analysis by ¹H NMR (THF-d₈). FIG. 3B shows rheological shear viscosities of UHMM l- and c-P3T(Me)₂P. FIG. 3C shows plots of R_{g} vs log (M_{w}) showing lower R_{g} for the cyclic polymer, c-P3T(Me)₂P (Mₙ=2.22 MDa), than the linear counterpart, l-P3T(Me)₂P (Mₙ=2.17 MDa). FIG. 3D shows two-dimensional height sensor data collected from AFM analysis of c-P3T(Me)₂P (1.0 mg/mL, 2000 rpm); polymer aggregates are discerned by the observed heights, approximately 77 nm for c-P3T(Me)₂P. FIG. 3E shows two-dimensional height sensor data collected from AFM analysis of comparative l-P3T(Me)₂P (1.0 mg/mL, 2000 rpm); polymer aggregates are discerned by the observed heights, approximately 34 nm for l-P3T(Me)₂P. FIG. 3F shows two-dimensional height sensor data collected from AFM analysis of comparative l-P3T(Me)₂P (0.01 mg/mL, 4000 rpm FIG. 3E shows three-dimensional height sensor data collected from AFM analysis of c-P3T(Me)₂P (0.01 mg/mL, 4000 rpm). FIG. 3H shows two-dimensional height sensor data collected from AFM analysis of comparative c-P3T(Me)₂P (0.01 mg/mL, 4000 rpm). FIG. 3I shows two-dimensional in-phase phase shift data collected from AFM analysis of c-P3T(Me)₂P (0.01 mg/mL, 4000 rpm).

FIGS. 4A-4D. Thermal, rheological, and mechanical properties of c-P3T(Me)₂P. FIG. 4A shows TGA and derivative thermogravimetric curves for UHMM c-P3T(Me)₂P (Mₙ=2.23 MDa). FIG. 4B shows overlays of shear viscosity in melt (shear rate \dot{r}=0.01 s⁻¹): UHMM c-P3T(Me)₂P (2.23 MDa, 130° C., black; 150° C., green; 170° C., blue). These plots demonstrate the melt-processability of UHMM c-P3T(Me)₂P. FIG. 4C shows overlays of storage modulus E′, loss modulus E″, and tan δ for UHMM c-P3T(Me)₂P measured by DMA (tension film mode, 0.05% strain, 1 Hz, 3° C. min⁻¹). FIG. 4D shows stress-strain curve overlays of UHMM c-P3T(Me)₂P (Mₙ=2.23 MDa) and c-P3T(Me)₂P (Mₙ=77.5 kDa) with LDPE (melt-flow index=7.5) and HDPE (melt-flow index=7.6). The impact of molar mass on mechanical properties is pivotal, with UHMM c-P3T(Me)₂P demonstrating high ultimate strength and elongation at break.

FIGS. 5A-5B. Chemical recycling to monomer. FIG. 5A shows overlays of ¹H NMR spectra (23° C., CDCl₃, with residual solvent peak at 7.26 ppm for CHCl₃), (1) virgin (Me)₂TPL, (2) the recovered monomer after depolymerization of c-P3T(Me)₂P (Mₙ=36.7 kDa, Ð=1.27), (3) the recovered monomer after depolymerization of l-P3T(Me)₂P (Mₙ=24.4 kDa, Ð=1.49), (4) virgin c-P3T(Me)₂P, (5) virgin l-P3T(Me)₂P. FIG. 5B shows a visual representation of the depolymerization of reprocessed c-P3T(Me)₂P film which was depolymerized with 3-5 wt % NaOH at 190-210° C. under vacuum to recover (Me)₂TPL.

FIG. 6. Examples of additional embodiments, including additional suitable monomers for use in the polymerization methods described herein (e.g., lactones, thiolactones, lactides, diolides, lactams, etc.) as well as examples of corresponding cyclic homopolymers, cyclic diblock copolymers, and cyclic triblock copolymers that can be prepared using the methods described herein.

FIG. 7. MALDI-TOF spectrum of c-P3T(Me)₂P produced by a [(Me)₂TPL]:[^{t}Bu-P4] ratio of 50:1.

FIG. 8. MALDI-TOF spectrum of c-P3H (Me)₂B produced by a [(Me)₂BL]:[^{t}Bu-P4] ratio of 50:1.

FIG. 9. MALDI-TOF spectrum of c-P(Me)₂VL produced by a [(Me)₂-δ-VL]:[^{t}Bu-P4] ratio of 50:1.

FIG. 10. ¹H NMR (CDCl₃, 23° C.) spectrum of PVL, produced by [δ-VL]:[^{t}Bu-P2]=10:1 at 0° C., precipitated in methanol. A cyclic structure was confirmed (no chain end visible).

FIG. 11. MALDI-TOF spectrum of c-PVL produced by a [δ-VL]:[^{t}Bu-P4] ratio of 10:1 at 0° C., precipitated in methanol. A cyclic structure was confirmed (no chain end visible).

FIG. 12. ¹H NMR (CDCl₃, 23° C.) spectrum of PCL, produced by [CL]:[^{t}Bu-P2]=10:1 at 0° C., precipitated in methanol. A cyclic structure was confirmed (no chain end visible).

### DETAILED DESCRIPTION

### Definitions

As used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

In this specification and in the claims which follow, reference will be made to a number of terms which shall be defined to have the following meanings:

“Optional” or “optionally” means that the subsequently described event or circumstance may or may not occur, and that the description includes instances where said event or circumstance occurs and instances where it does not.

The term “n-membered” where n is an integer typically describes the number of ring-forming atoms in a moiety where the number of ring-forming atoms is n. For example, piperidinyl is an example of a 6-membered heterocycloalkyl ring, pyrazolyl is an example of a 5-membered heteroaryl ring, pyridyl is an example of a 6-membered heteroaryl ring, and 1,2,3,4-tetrahydro-naphthalene is an example of a 10-membered cycloalkyl group.

As used herein, the phrase “optionally substituted” means unsubstituted or substituted. As used herein, the term “substituted” means that a hydrogen atom is removed and replaced by a substituent. It is to be understood that substitution at a given atom is limited by valency.

Throughout the definitions, the term “Cₙ₋ₘ” indicates a range which includes the endpoints, wherein n and m are integers and indicate the number of carbons. Examples include C₁₋₄, C₁₋₆, and the like.

As used herein, the term “Cₙ₋ₘ alkyl”, employed alone or in combination with other terms, refers to a saturated hydrocarbon group that may be straight-chain or branched, having n to m carbons. Examples of alkyl moieties include, but are not limited to, chemical groups such as methyl, ethyl, n-propyl, isopropyl, n-butyl, tert-butyl, isobutyl, sec-butyl; higher homologs such as 2-methyl-1-butyl, n-pentyl, 3-pentyl, n-hexyl, 1,2,2-trimethylpropyl, and the like. In some embodiments, the alkyl group contains from 1 to 6 carbon atoms, from 1 to 4 carbon atoms, from 1 to 3 carbon atoms, or 1 to 2 carbon atoms.

As used herein, “Cₙ₋ₘ alkenyl” refers to an alkyl group having one or more double carbon-carbon bonds and having n to m carbons. Example alkenyl groups include, but are not limited to, ethenyl, n-propenyl, isopropenyl, n-butenyl, sec-butenyl, and the like. In some embodiments, the alkenyl moiety contains 2 to 6, 2 to 4, or 2 to 3 carbon atoms.

As used herein, “Cₙ₋ₘ alkynyl” refers to an alkyl group having one or more triple carbon-carbon bonds and having n to m carbons. Example alkynyl groups include, but are not limited to, ethynyl, propyn-1-yl, propyn-2-yl, and the like. In some embodiments, the alkynyl moiety contains 2 to 6, 2 to 4, or 2 to 3 carbon atoms.

As used herein, the term “Cₙ₋ₘ alkylene”, employed alone or in combination with other terms, refers to a divalent alkyl linking group having n to m carbons. Examples of alkylene groups include, but are not limited to, ethan-1,2-diyl, propan-1,3-diyl, propan-1,2-diyl, butan-1,4-diyl, butan-1,3-diyl, butan-1,2-diyl, 2-methyl-propan-1,3-diyl, and the like. In some embodiments, the alkylene moiety contains 2 to 6, 2 to 4, 2 to 3, 1 to 6, 1 to 4, or 1 to 2 carbon atoms.

As used herein, the term “Cₙ₋ₘ alkoxy”, employed alone or in combination with other terms, refers to a group of formula —O-alkyl, wherein the alkyl group has n to m carbons. Example alkoxy groups include methoxy, ethoxy, propoxy (e.g., n-propoxy and isopropoxy), tert-butoxy, and the like. In some embodiments, the alkyl group has 1 to 6, 1 to 4, or 1 to 3 carbon atoms.

As used herein, the term “Cₙ₋ₘ alkylamino” refers to a group of formula —NH(alkyl), wherein the alkyl group has n to m carbon atoms. In some embodiments, the alkyl group has 1 to 6, 1 to 4, or 1 to 3 carbon atoms.

As used herein, the term “Cₙ₋ₘ alkoxycarbonyl” refers to a group of formula —C(O)O-alkyl, wherein the alkyl group has n to m carbon atoms. In some embodiments, the alkyl group has 1 to 6, 1 to 4, or 1 to 3 carbon atoms.

As used herein, the term “Cₙ₋ₘ alkylcarbonyl” refers to a group of formula —C(O)-alkyl, wherein the alkyl group has n to m carbon atoms. In some embodiments, the alkyl group has 1 to 6, 1 to 4, or 1 to 3 carbon atoms.

As used herein, the term “Cₙ₋ₘ alkylcarbonylamino” refers to a group of formula —NHC(O)-alkyl, wherein the alkyl group has n to m carbon atoms. In some embodiments, the alkyl group has 1 to 6, 1 to 4, or 1 to 3 carbon atoms.

As used herein, the term “Cₙ₋ₘ alkylsulfonylamino” refers to a group of formula —NHS(O)₂-alkyl, wherein the alkyl group has n to m carbon atoms. In some embodiments, the alkyl group has 1 to 6, 1 to 4, or 1 to 3 carbon atoms.

As used herein, the term “aminosulfonyl” refers to a group of formula —S(O)₂NH₂.

As used herein, the term “Cₙ₋ₘ alkylaminosulfonyl” refers to a group of formula —S(O)₂NH(alkyl), wherein the alkyl group has n to m carbon atoms. In some embodiments, the alkyl group has 1 to 6, 1 to 4, or 1 to 3 carbon atoms.

As used herein, the term “di(Cₙ₋ₘ alkyl)aminosulfonyl” refers to a group of formula —S(O)₂N(alkyl)₂, wherein each alkyl group independently has n to m carbon atoms. In some embodiments, each alkyl group has, independently, 1 to 6, 1 to 4, or 1 to 3 carbon atoms.

As used herein, the term “aminosulfonylamino” refers to a group of formula —NHS(O)₂NH₂.

As used herein, the term “Cₙ₋ₘ alkylaminosulfonylamino” refers to a group of formula —NHS(O)₂NH(alkyl), wherein the alkyl group has n to m carbon atoms. In some embodiments, the alkyl group has 1 to 6, 1 to 4, or 1 to 3 carbon atoms.

As used herein, the term “di(Cₙ₋ₘ alkyl)aminosulfonylamino” refers to a group of formula —NHS(O)₂N(alkyl)₂, wherein each alkyl group independently has n to m carbon atoms. In some embodiments, each alkyl group has, independently, 1 to 6, 1 to 4, or 1 to 3 carbon atoms.

As used herein, the term “aminocarbonylamino”, employed alone or in combination with other terms, refers to a group of formula —NHC(O) NH₂.

As used herein, the term “Cₙ₋ₘ alkylaminocarbonylamino” refers to a group of formula —NHC(O) NH(alkyl), wherein the alkyl group has n to m carbon atoms. In some embodiments, the alkyl group has 1 to 6, 1 to 4, or 1 to 3 carbon atoms.

As used herein, the term “di(Cₙ₋ₘ alkyl)aminocarbonylamino” refers to a group of formula —NHC(O) N(alkyl)₂, wherein each alkyl group independently has n to m carbon atoms. In some embodiments, each alkyl group has, independently, 1 to 6, 1 to 4, or 1 to 3 carbon atoms.

As used herein, the term “Cₙ₋ₘ alkylcarbamyl” refers to a group of formula —C(O)—NH(alkyl), wherein the alkyl group has n to m carbon atoms. In some embodiments, the alkyl group has 1 to 6, 1 to 4, or 1 to 3 carbon atoms.

As used herein, the term “thio” refers to a group of formula —SH.

As used herein, the term “Cₙ₋ₘ alkylsulfinyl” refers to a group of formula —S(O)-alkyl, wherein the alkyl group has n to m carbon atoms. In some embodiments, the alkyl group has 1 to 6, 1 to 4, or 1 to 3 carbon atoms.

As used herein, the term “Cₙ₋ₘ alkylsulfonyl” refers to a group of formula —S(O)₂-alkyl, wherein the alkyl group has n to m carbon atoms. In some embodiments, the alkyl group has 1 to 6, 1 to 4, or 1 to 3 carbon atoms.

As used herein, the term “amino” refers to a group of formula —NH₂.

As used herein, the term “aryl,” employed alone or in combination with other terms, refers to an aromatic hydrocarbon group, which may be monocyclic or polycyclic (e.g., having 2, 3 or 4 fused rings). The term “Cₙ₋ₘ aryl” refers to an aryl group having from n to m ring carbon atoms. Aryl groups include, e.g., phenyl, naphthyl, anthracenyl, phenanthrenyl, indanyl, indenyl, and the like. In some embodiments, aryl groups have from 6 to about 20 carbon atoms, from 6 to about 15 carbon atoms, or from 6 to about 10 carbon atoms. In some embodiments, the aryl group is a substituted or unsubstituted phenyl.

As used herein, the term “carbamyl” to a group of formula —C(O) NH₂.

As used herein, the term “carbonyl”, employed alone or in combination with other terms, refers to α-C(═O)— group, which may also be written as C(O).

As used herein, the term “di(Cₙ₋ₘ-alkyl)amino” refers to a group of formula —N(alkyl)₂, wherein the two alkyl groups each has, independently, n to m carbon atoms. In some embodiments, each alkyl group independently has 1 to 6, 1 to 4, or 1 to 3 carbon atoms.

As used herein, the term “di(Cₙ₋ₘ-alkyl) carbamyl” refers to a group of formula —C(O) N(alkyl)₂, wherein the two alkyl groups each has, independently, n to m carbon atoms. In some embodiments, each alkyl group independently has 1 to 6, 1 to 4, or 1 to 3 carbon atoms.

As used herein, the term “halo” refers to F, Cl, Br, or I. In some embodiments, a halo is F, Cl, or Br. In some embodiments, a halo is F or Cl.

As used herein, “Cₙ₋ₘ haloalkoxy” refers to a group of formula —O-haloalkyl having n to m carbon atoms. An example of a haloalkoxy group is OCF₃. In some embodiments, the haloalkoxy group is fluorinated only. In some embodiments, the alkyl group has 1 to 6, 1 to 4, or 1 to 3 carbon atoms.

As used herein, the term “Cₙ₋ₘ haloalkyl”, employed alone or in combination with other terms, refers to an alkyl group having from one halogen atom to 2s+1 halogen atoms which may be the same or different, where “s” is the number of carbon atoms in the alkyl group, wherein the alkyl group has n to m carbon atoms. In some embodiments, the haloalkyl group is fluorinated only. In some embodiments, the alkyl group has 1 to 6, 1 to 4, or 1 to 3 carbon atoms.

As used herein, “cycloalkyl” refers to non-aromatic cyclic hydrocarbons including cyclized alkyl and/or alkenyl groups. Cycloalkyl groups can include mono- or polycyclic (e.g., having 2, 3 or 4 fused rings) groups and spirocycles. Cycloalkyl groups can have 3, 4, 5, 6, 7, 8, 9, or 10 ring-forming carbons (C₃₋₁₀). Ring-forming carbon atoms of a cycloalkyl group can be optionally substituted by oxo or sulfido (e.g., C(O) or C(S)). Cycloalkyl groups also include cycloalkylidenes. Example cycloalkyl groups include cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcarnyl, and the like. In some embodiments, cycloalkyl is cyclopropyl, cyclobutyl, cyclopentyl, cyclohexyl, cyclopentyl, or adamantyl. In some embodiments, the cycloalkyl has 6-10 ring-forming carbon atoms. In some embodiments, cycloalkyl is adamantyl. Also included in the definition of cycloalkyl are moieties that have one or more aromatic rings fused (i.e., having a bond in common with) to the cycloalkyl ring, for example, benzo or thienyl derivatives of cyclopentane, cyclohexane, and the like. A cycloalkyl group containing a fused aromatic ring can be attached through any ring-forming atom including a ring-forming atom of the fused aromatic ring.

As used herein, “heteroaryl” refers to a monocyclic or polycyclic aromatic heterocycle having at least one heteroatom ring member selected from sulfur, oxygen, and nitrogen. In some embodiments, the heteroaryl ring has 1, 2, 3, or 4 heteroatom ring members independently selected from nitrogen, sulfur and oxygen. In some embodiments, any ring-forming N in a heteroaryl moiety can be an N-oxide. In some embodiments, the heteroaryl has 5-10 ring atoms and 1, 2, 3 or 4 heteroatom ring members independently selected from nitrogen, sulfur and oxygen. In some embodiments, the heteroaryl has 5-6 ring atoms and 1 or 2 heteroatom ring members independently selected from nitrogen, sulfur and oxygen. In some embodiments, the heteroaryl is a five-membered or six-membered heteroaryl ring. A five-membered heteroaryl ring is a heteroaryl with a ring having five ring atoms wherein one or more (e.g., 1, 2, or 3) ring atoms are independently selected from N, O, and S. Exemplary five-membered ring heteroaryls are thienyl, furyl, pyrrolyl, imidazolyl, thiazolyl, oxazolyl, pyrazolyl, isothiazolyl, isoxazolyl, 1,2,3-triazolyl, tetrazolyl, 1,2,3-thiadiazolyl, 1,2,3-oxadiazolyl, 1,2,4-triazolyl, 1,2,4-thiadiazolyl, 1,2,4-oxadiazolyl, 1,3,4-triazolyl, 1,3,4-thiadiazolyl, and 1,3,4-oxadiazolyl. A six-membered heteroaryl ring is a heteroaryl with a ring having six ring atoms wherein one or more (e.g., 1, 2, or 3) ring atoms are independently selected from N, O, and S. Exemplary six-membered ring heteroaryls are pyridyl, pyrazinyl, pyrimidinyl, triazinyl and pyridazinyl.

As used herein, “heterocycloalkyl” refers to non-aromatic monocyclic or polycyclic heterocycles having one or more ring-forming heteroatoms selected from O, N, or S. Included in heterocycloalkyl are monocyclic 4-, 5-, 6-, and 7-membered heterocycloalkyl groups. Heterocycloalkyl groups can also include spirocycles. Example heterocycloalkyl groups include pyrrolidin-2-one, 1,3-isoxazolidin-2-one, pyranyl, tetrahydropurin, oxetanyl, azetidinyl, morpholino, thiomorpholino, piperazinyl, tetrahydrofuranyl, tetrahydrothienyl, piperidinyl, pyrrolidinyl, isoxazolidinyl, isothiazolidinyl, pyrazolidinyl, oxazolidinyl, thiazolidinyl, imidazolidinyl, azepanyl, benzazepine, and the like. Ring-forming carbon atoms and heteroatoms of a heterocycloalkyl group can be optionally substituted by oxo or sulfido (e.g., C(O), S(O), C(S), or S(O)₂, etc.). The heterocycloalkyl group can be attached through a ring-forming carbon atom or a ring-forming heteroatom. In some embodiments, the heterocycloalkyl group contains 0 to 3 double bonds. In some embodiments, the heterocycloalkyl group contains 0 to 2 double bonds. Also included in the definition of heterocycloalkyl are moieties that have one or more aromatic rings fused (i.e., having a bond in common with) to the cycloalkyl ring, for example, benzo or thienyl derivatives of piperidine, morpholine, azepine, etc. A heterocycloalkyl group containing a fused aromatic ring can be attached through any ring-forming atom including a ring-forming atom of the fused aromatic ring. In some embodiments, the heterocycloalkyl has 4-10, 4-7 or 4-6 ring atoms with 1 or 2 heteroatoms independently selected from nitrogen, oxygen, or sulfur and having one or more oxidized ring members.

At certain places, the definitions or embodiments refer to specific rings (e.g., an azetidine ring, a pyridine ring, etc.). Unless otherwise indicated, these rings can be attached to any ring member provided that the valency of the atom is not exceeded. For example, an azetidine ring may be attached at any position of the ring, whereas a pyridin-3-yl ring is attached at the 3-position.

The term “compound” as used herein is meant to include all stereoisomers, geometric isomers, tautomers, and isotopes of the structures depicted. Compounds herein identified by name or structure as one particular tautomeric form are intended to include other tautomeric forms unless otherwise specified.

Compounds provided herein also include tautomeric forms. Tautomeric forms result from the swapping of a single bond with an adjacent double bond together with the concomitant migration of a proton. Tautomeric forms include prototropic tautomers which are isomeric protonation states having the same empirical formula and total charge. Example prototropic tautomers include ketone-enol pairs, amide-imidic acid pairs, lactam-lactim pairs, enamine-imine pairs, and annular forms where a proton can occupy two or more positions of a heterocyclic system, for example, 1H- and 3H-imidazole, 1H-, 2H- and 4H-1,2,4-triazole, 1H- and 2H-isoindole, and 1H- and 2H-pyrazole. Tautomeric forms can be in equilibrium or sterically locked into one form by appropriate substitution.

In some embodiments, the compounds described herein can contain one or more asymmetric centers and thus occur as racemates and racemic mixtures, enantiomerically enriched mixtures, single enantiomers, individual diastereomers and diastereomeric mixtures (e.g., including (R)- and(S)-enantiomers, diastereomers, (D)-isomers, (L)-isomers, (+) (dextrorotatory) forms, (−) (levorotatory) forms, the racemic mixtures thereof, and other mixtures thereof). Additional asymmetric carbon atoms can be present in a substituent, such as an alkyl group. All such isomeric forms, as well as mixtures thereof, of these compounds are expressly included in the present description. The compounds described herein can also or further contain linkages wherein bond rotation is restricted about that particular linkage, e.g., restriction resulting from the presence of a ring or double bond (e.g., carbon-carbon bonds, carbon-nitrogen bonds such as amide bonds). Accordingly, all cis/trans and E/Z isomers and rotational isomers are expressly included in the present description. Unless otherwise mentioned or indicated, the chemical designation of a compound encompasses the mixture of all possible stereochemically isomeric forms of that compound.

Optical isomers can be obtained in pure form by standard procedures known to those skilled in the art, and include, but are not limited to, diastereomeric salt formation, kinetic resolution, and asymmetric synthesis. See, for example, Jacques, et al., Enantiomers, Racemates and Resolutions (Wiley Interscience, New York, 1981); Wilen, S. H., et al., Tetrahedron 33:2725 (1977); Eliel, E. L. Stereochemistry of Carbon Compounds (McGraw-Hill, NY, 1962); Wilen, S. H. Tables of Resolving Agents and Optical Resolutions p. 268 (E. L. Eliel, Ed., Univ. of Notre Dame Press, Notre Dame, IN 1972), each of which is incorporated herein by reference in their entireties. It is also understood that the compounds described herein include all possible regioisomers, and mixtures thereof, which can be obtained in pure form by standard separation procedures known to those skilled in the art, and include, but are not limited to, column chromatography, thin-layer chromatography, and high-performance liquid chromatography.

A “solvent” as described herein can include water or an organic solvent. Examples of organic solvents include hydrocarbons such as toluene, xylene, hexane, and heptane; chlorinated solvents such as methylene chloride, chloroform, and dichloroethane; ethers such as diethyl ether, tetrahydrofuran, and dibutyl ether; ketones such as acetone and 2-butanone; esters such as ethyl acetate and butyl acetate; nitriles such as acetonitrile; alcohols such as methanol, ethanol, and tert-butanol; and aprotic polar solvents such as N,N-dimethylformamide (DMF), N,N-dimethylacetamide (DMA), and dimethyl sulfoxide (DMSO). Solvents may be used alone or two or more of them may be mixed for use to provide a “solvent system”.

A non-polar solvent is a liquid or solvent that has a low or non-existing dipole moment and is missing any partial positive or negative charges. Generally, it has small differences in electronegativity between atoms in the solvent molecule and has a low dielectric constant. A non-polar solvents cannot effectively dissolve a polar compound. Examples of a non-polar solvent includes alkanes, toluene, chloroform and diethyl ether.

The term, “repeat unit”, “repeating unit”, or “block” as used herein refers to the moiety of a polymer that is repetitive. The repeat unit may comprise one or more repeat units, labeled as, for example, repeat unit A, repeat unit B, repeat unit C, etc. Repeat units A-C, for example, may be covalently bound together to form a combined repeat unit. Monomers or a combination of one or more different monomers can be combined to form a (combined) repeat unit of a polymer or copolymer.

The term “molecular weight” for the copolymers disclosed herein refers to the average number molecular weight (Mₙ). The corresponding weight average molecular weight (M_{w}) can be determined from other disclosed parameters by methods (e.g., by calculation) known to the skilled artisan.

The copolymers disclosed herein can comprise random or block copolymers. In various embodiments, the ends of the polymer or copolymer (i.e., the initiator end or terminal end), is a low molecular weight moiety (e.g. under 500 Da), such as, H, OH, OOH, CH2OH, CN, NH2, or a hydrocarbon such as an alkyl (for example, a butyl or 2-cyanoprop-2-yl moiety at the initiator and terminal end), alkene or alkyne, or a moiety as a result of an elimination reaction at the first and/or last repeat unit in the copolymer.

### Cyclic Polymers and Methods of Making Thereof

### Disclosed Herein are Cyclic Polymers Defined by Formula I Below

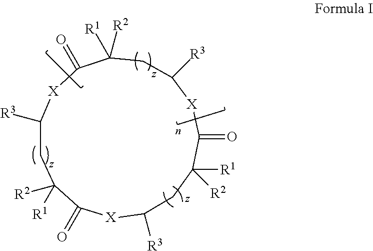

wherein R¹ and R² are individually hydrogen, C1-C12 alkyl, C2-C12 alkenyl, C2-C12 alkynyl, aryl, or heteroaryl, or R¹ and R² together with the atom to which they are attached form a cycloalkyl ring; R³ is hydrogen, C1-C12 alkyl, C2-C12 alkenyl, C2-C12 alkynyl, aryl, or heteroaryl; X is selected from O, S, and NR^{A}, wherein R^{A} is H or C1-C12 alkyl; z is an integer from 0 to 16; and n is an integer from 10 to 500,000.

In some embodiments, the polymer has a number average molecular weight of at least 1 MDa. In some embodiments, the polymer comprises an ultrahigh-molar-mass polymer having a number average molecular weight of at least 2 MDa.

In some embodiments, the polymer exhibits a dispersity (Ð) of 1.4 or less, such as a dispersity of from greater than 1 to 1.4, from 1.1 to 1.4, from 1.2 to 1.4, from greater than 1 to 1.3, from 1.1 to 1.3, from 1.2 to 1.3, from greater that 1 to 1.2, from 1.1 to 1.2, or from greater than 1 to 1.1.

In some embodiments, R¹ and R² are each individually methyl, ethyl, propyl, butyl, pentyl, hexyl, or heptyl. In some embodiments, R³ is H, methyl, ethyl, propyl, or butyl, pentyl, hexyl, or heptyl.

In some embodiments, R¹ and R² are methyl, ethyl, propyl, or butyl. In some embodiments, R³ is hydrogen, methyl, ethyl, propyl, or butyl. In certain embodiments, R¹ and R² are methyl, ethyl, propyl, or butyl and R³ is hydrogen, methyl, ethyl, propyl, or butyl.

In some embodiments, z is 0, 1 or 2.

In some embodiments, n is an integer from 5,000 to 500,000 (e.g., from 10,000 to 500,000, from 50,000 to 500,000, from 100,000 to 500,000, from 200,000 to 500,000, or from 250,000 to 500,000). In some embodiments, n is an integer from 100 to 500,000, from 100 to 100,000, from 1,000 to 500,000, from 1,000 to 100,000, from 5,000 to 500,000, or from 5,000 to 100,000.

In some embodiments, the polymer comprises a cyclic block copolymer (e.g., a cyclic diblock copolymer or a cyclic triblock copolymer). By way of example, in certain embodiments, the polymer comprises a cyclic block copolymer defined by Formula II below

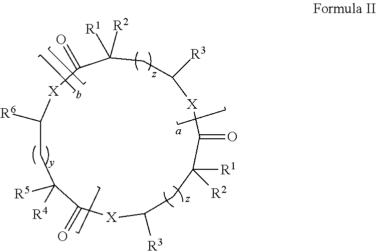

wherein X is selected from O, S, and NR^{A}, wherein R^{A} is H or C1-C12 alkyl; R¹ and R² are individually hydrogen, C1-C12 alkyl, C2-C12 alkenyl, C2-C12 alkynyl, aryl, or heteroaryl, or R¹ and R² together with the atom to which they are attached form a cycloalkyl ring; R³ is hydrogen, C1-C12 alkyl, C2-C12 alkenyl, C2-C12 alkynyl, aryl, or heteroaryl; R⁴ and R⁵ are individually hydrogen, C1-C12 alkyl, C2-C12 alkenyl, C2-C12 alkynyl, aryl, or heteroaryl, or R⁴ and R⁵ together with the atom to which they are attached form a cycloalkyl ring; R⁶ is hydrogen, C1-C12 alkyl, C2-C12 alkenyl, C2-C12 alkynyl, aryl, or heteroaryl; X is selected from O, S, and NR^{A}, wherein R^{A} is H or C1-C12 alkyl; y is an integer from 0 to 16; z is an integer from 0 to 16; and a is an integer from 5 to 490,000 and b is an integer from 5 to 490,000, wherein the sum of a and b is from 10 to 500,000; wherein the structure of the repeating units represented by x and y of Formula II are different.

In some embodiments, R¹, R², R⁴, and R⁵ are each individually methyl, ethyl, propyl, butyl, pentyl, hexyl, or heptyl. In some embodiments, R³ and R⁶ are H, methyl, ethyl, propyl, or butyl, pentyl, hexyl, or heptyl.

In some embodiments, R¹, R², R⁴, and R⁵ are methyl, ethyl, propyl, or butyl. In some embodiments, R³ and R⁶ are hydrogen, methyl, ethyl, propyl, or butyl. In certain embodiments, R¹, R², R⁴, and R⁵ are methyl, ethyl, propyl, or butyl and R³ and R⁶ are hydrogen, methyl, ethyl, propyl, or butyl.

In some embodiments, y is 0, 1 or 2 and z is 0, 1, or 2.

Also provided herein are methods for preparing a cyclic polymer. These methods can comprise ring opening polymerization (ROP) of a monomer of Formula III

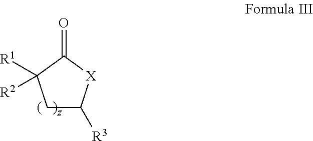

wherein R¹ and R² are individually hydrogen, C1-C12 alkyl, C2-C12 alkenyl, C2-C12 alkynyl, aryl, or heteroaryl, or R¹ and R² together with the atom to which they are attached form a cycloalkyl ring; R³ is hydrogen, C1-C12 alkyl, C2-C12 alkenyl, C2-C12 alkynyl, aryl, or heteroaryl; X is selected from O, S, and NR^{A}, wherein R^{A} is H or C1-C12 alkyl; and z is an integer from 0 to 16; wherein ROP comprises contacting the monomer of Formula III with a catalyst to form a linear ROP product; and protic quenching the linear ROP product.

In some embodiments, the cyclic polymer prepared by the methods described herein has a number average molecular weight of at least 1 MDa. In some embodiments, the cyclic polymer comprises an ultrahigh-molar-mass polymer having a number average molecular weight of at least 2 MDa.

In some embodiments, the cyclic polymer exhibits a dispersity (Ð) of 1.4 or less, such as a dispersity of from greater than 1 to 1.4, from 1.1 to 1.4, from 1.2 to 1.4, from greater than 1 to 1.3, from 1.1 to 1.3, from 1.2 to 1.3, from greater that 1 to 1.2, from 1.1 to 1.2, or from greater than 1 to 1.1.

In some embodiments, R¹ and R² are each individually methyl, ethyl, propyl, butyl, pentyl, hexyl, or heptyl. In some embodiments, R³ is H, methyl, ethyl, propyl, or butyl, pentyl, hexyl, or heptyl.

In some embodiments, R¹ and R² are methyl, ethyl, propyl, or butyl. In some embodiments, R³ is hydrogen, methyl, ethyl, propyl, or butyl. In certain embodiments, R¹ and R² are methyl, ethyl, propyl, or butyl and R³ is hydrogen, methyl, ethyl, propyl, or butyl.

In some embodiments, z is 0, 1 or 2.

In some embodiments, the monomer of Formula III can comprise one or more of the following.

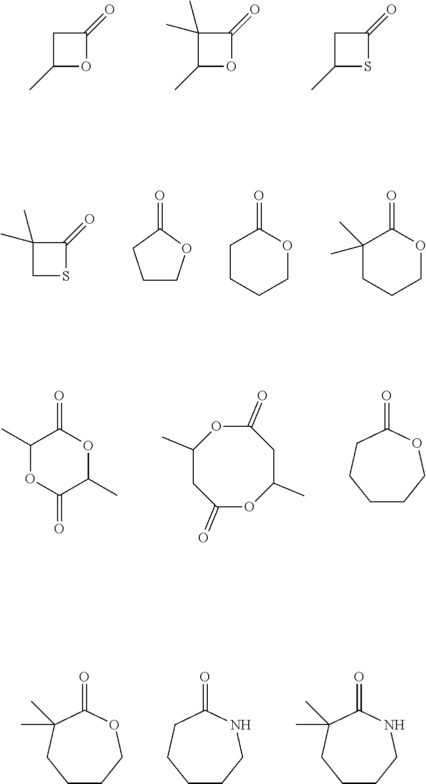

The ROP can be carried out under solvent-free conditions (i.e., bulk polymerization), or in solution (e.g., in toluene, methylene chloride). In some embodiments, the ROP can be performed at room temperature.

The catalyst can comprise an organic catalyst. Organic catalysts for ROP are strong organic bases or nucleophiles, such as 1,5,7-triazabicyclo[4.4.0]dec-5-ene (TBD), that can either directly initiate the polymerization or activate a protic initiator to promote the polymerization. Basic catalysts can be grouped into two general classes: strong organic bases and inorganic bases. They can be used alone but are often used in combination with a protic initiator. Organic catalysts include strong organic bases, especially polyaminophosphazene superbases such as TBD, 1-tert-butyl-4,4,4-tris(dimethylamino)-2,2-bis[tris(dimethylamino)-phosphoranylideneamino]-2λ⁵,4λ⁵-catenadi (phosphazene) (^{t}Bu-P₄); guanidines such as. proazaphosphatranes (cyclic azaphosphines), and cyclopropanamine superbases, including the following catalysts. Anionic versions of organic catalysts/initiators such as urea or thiourea anions can also be used.

In some embodiments, the catalyst can comprise a sterically bulky organic base. In some embodiments, the catalyst comprises a superbase. In some embodiments, the catalyst can comprise a phosphazene base. Examples of phosphazene bases are described, for example, in International Publication No. WO 94/08952, which is hereby incorporated by reference in its entirety.

In some embodiments, the catalyst comprises one of the following:

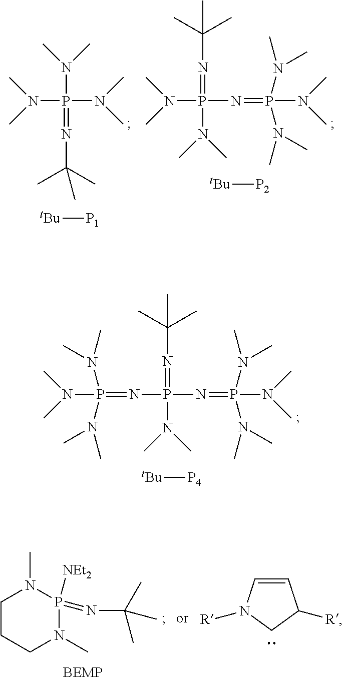

where R′ is alkyl or aryl.

In certain embodiments, the catalyst comprises 1-tert-butyl-4,4,4-tris(dimethylamino)-2,2-bis[tris(dimethylamino)-phosphoranylideneamino]-275,425-catenadi (phosphazene) (^{t}Bu-P4).

In some embodiments, the catalyst comprises 1,5,7-triazabicyclo[4.4.0]dec-5-ene (TBD).

Protic quenching can trigger macromolecular cyclization of the linear ROP product, thereby forming the cyclic polymer. In some embodiments, protic quenching comprising contacting the linear ROP product with a protic solvent, such as an alcohol or an acidified alcohol. The alcohol or acidified alcohol can comprise, for example, an aliphatic alcohol, an aryl alcohol, a diol, a polyol, benzyl alcohol (BnOH), methanol, ethanol, propanol, isopropanol, butanol, an amine, or a thiol. The alcohol can be acidified through the addition of any suitable organic or mineral acid.

In some embodiments, protic quenching is performed after all of the monomer of Formula III has been polymerized.

In some embodiments, the method is performed as a one-pot process.

Also provided herein are methods for depolymerizing the cyclic polymers described herein. These methods can comprise contacting the cyclic polymer with a base, wherein the cyclic polymer is depolymerized to its constituent monomer and conversion to the constituent monomer is 20 wt. % or more. In some embodiments, the wt. % conversion is about 30%, about 40%, about 50%, about 60%, about 70%, about 80%, about 90%, about 95%, or about 99%.

In some embodiments, the base is an aqueous base. In some embodiments, the base is an alkali base. In some embodiments, the base is sodium hydroxide or lithium hydroxide. In some embodiments, the base is an inorganic base. In some embodiments, inorganic base is an alkoxide like sodium hydroxide, an oxide such as lithium oxide, a hydride such as potassium hydride, a carbonate such as potassium carbonate. In some embodiments, the inorganic base can be replaced with a salt such as lithium chloride.

In some embodiments, depolymerizing comprises warming or heating to facilitate a depolymerization reaction. In some embodiments, warming or heating is performed at a temperature above room temperature, about 50° C., about 100° C., about 150° C., about 200° C., about 210° C., about 220° C., about 230° C., about 240° C., about 250° C., about 260° C., about 280° C., or about 300° C. The monomer can be recovered by via distillation, sublimation, etc.

In some embodiments, the constituent monomer can comprise a monomer defined by Formula III

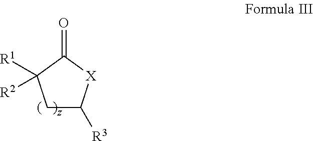

wherein R¹ and R² are individually hydrogen, C1-C12 alkyl, C2-C12 alkenyl, C2-C12 alkynyl, aryl, or heteroaryl, or R¹ and R² together with the atom to which they are attached form a cycloalkyl ring; R³ is hydrogen, C1-C12 alkyl, C2-C12 alkenyl, C2-C12 alkynyl, aryl, or heteroaryl; X is selected from O, S, and NR^{A}, wherein R^{A} is H or C1-C12 alkyl; and z is an integer from 0 to 16.

In some embodiments, the constituent monomer can comprise a monomer defined by Formula

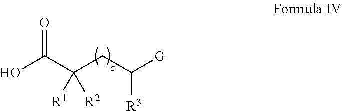

wherein R¹ and R² are individually hydrogen, C1-C12 alkyl, C2-C12 alkenyl, C2-C12 alkynyl, aryl, or heteroaryl, or R¹ and R² together with the atom to which they are attached form a cycloalkyl ring; R³ is hydrogen, C1-C12 alkyl, C2-C12 alkenyl, C2-C12 alkynyl, aryl, or heteroaryl; G is selected from OH, SH, and NHR^{A}, wherein R^{A} is H or C1-C12 alkyl; and z is an integer from 0 to 16.

By way of non-limiting illustration, examples of certain embodiments of the present disclosure are given below.

### EXAMPLES

### Summary

The selective synthesis of ultrahigh-molar-mass (UHMM, >2 million Da) cyclic polymers is challenging as an exceptional degree of spatiotemporal control is required to overcome the possible undesired reactions that can compete with the desired intramolecular cyclization. In this example, we present a counterintuitive synthetic methodology for cyclic polymers, represented here by polythioesters, which proceeds via superbase-mediated ring-opening polymerization of gem-dimethylated thiopropiolactone, followed by macromolecular cyclization triggered by protic quenching. This proton-triggered linear-to-cyclic topological transformation enables selective, linear-polymer-like access to desired cyclic polythioesters, including those with UHMM surpassing 2 MDa. In addition, this method eliminates the need for stringent conditions such as high dilution to prevent or suppress linear polymer contaminants and presents, intriguingly, the opposite scenario where protic-free conditions are required to prevent cyclic polymer formation, which is capitalized to produce cyclic polymers on-demand. Furthermore, such UHMM cyclic polythioester exhibits not only much enhanced thermostability and mechanical toughness, but it can also be quantitatively recycled back to monomer under mild conditions due to its gem-disubstitution.

### Introduction

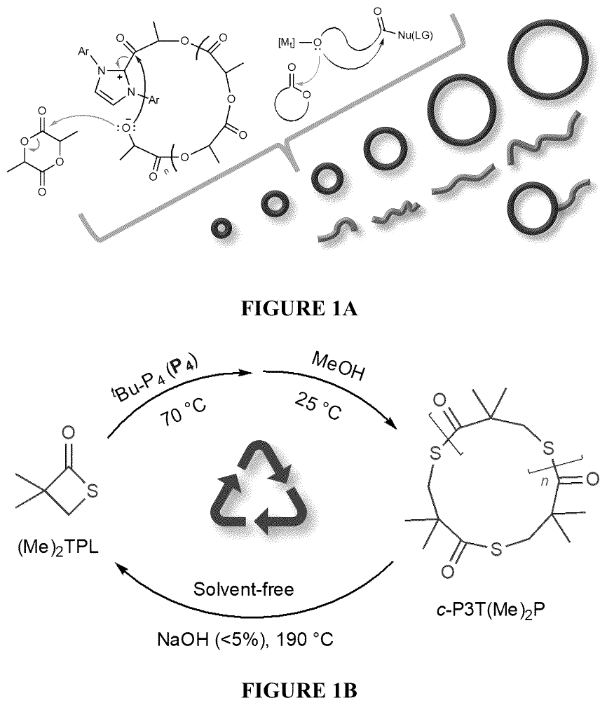

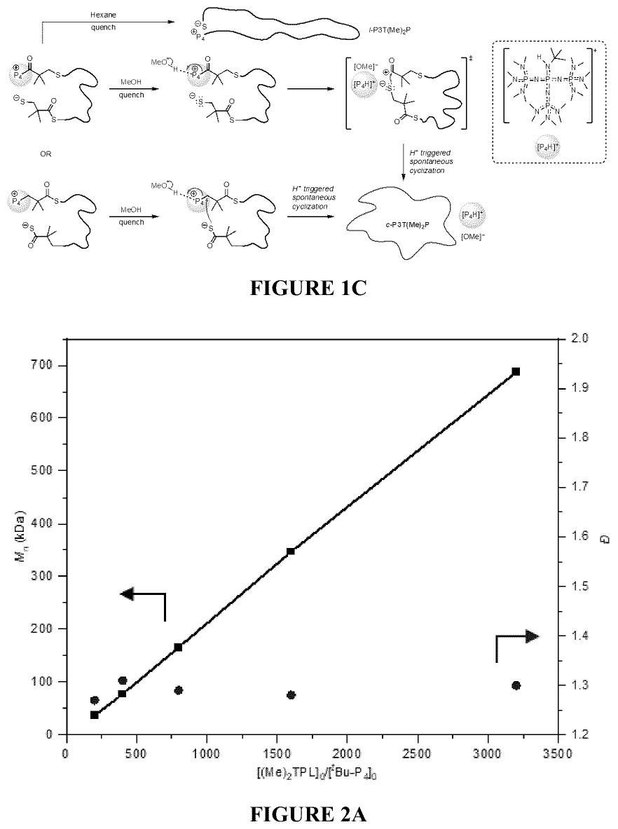

Ring-opening polymerization (ROP) of heterocyclic monomers has been used to produce cyclic polymers via in-situ cyclization of propagating species. However, regardless of whether the ROP is organically initiated zwitterionic or metal-catalyzed coordinative-insertion mechanisms, the enabling step is in-polymerization cyclization (polymerization and cyclization events occur concurrently) of a growing chain, which always competes with linear chain propagation, thus often resulting in formation of cyclic polymers with uncontrolled molar mass and high dispersity (i.e., forming rings in large size variations) as well as linear contaminants (FIG. 1A). Using such existing methods to access cyclic polymers with ultrahigh-molar-mass [UHMM, defined here with number-average molar mass (Mₙ)>2 million Dalton (MDa)] and in high selectivity is particularly challenging, due to competing propagation/cyclization processes and other side reactions such as chain transfer or termination under high monomer-to-initiator/catalyst conditions. Ideally, if cyclization occurs only when an external trigger is applied, then cyclic polymers should be synthesizable in the same manner as linear counterparts, thereby accessing cyclic polymers with the same precision and designability as the linear ones, including UHMM cyclic polymers with low dispersity (Ð<1.4).

To realize this intriguing possibility and demonstrate the concept, we investigated the organic ROP of 2,2-dimethyl-3-thiopropiolactone [(Me)₂TPL] aiming for the corresponding cyclic polythioester, poly(2,2-dimethyl-3-thiopropiolactone) [c-P3T(Me)₂P] (FIG. 1B), based on the following four hypotheses. First, cyclic, sulfur-containing polythioester with UHMM may provide a unique opportunity for direct visualization by microscopies such as Atomic Force Microscope (AFM), thus eliminating the need for post-polymerization functionalization via thiol-ene click to enable visualization. Second, owing to lability of thioester bonds, back-biting cyclization via transthioesterification should be more facile than transesterification of polyester chains, facilitating cyclic polythioester formation. This reasoning was beautifully demonstrated by the recent work of Guillaume and Carpentier that the metal-mediated ROP of an analogous four-membered thiolactone, (±)-β-thiobutyrolactone, forms cyclic poly(3-thiobutyrolactone) (c-P3 TB) enabled by in-polymerization back-biting cyclization. Isotactic and syndiotactic c-P3 TB materials were synthesized using different yttrium-based catalysts, but the reported Mₙ was only up to 46.5 kDa and the recycling of P3 TB to monomer was not demonstrated. Obtaining cyclic polymers with high molar mass and chemical circularity is essential for achieving high-performance materials and circular economy. Third, installation of α,α-gem-dimethyl groups to the thiopropiolactone ring should increase the depolymerizability of the polythioester back to its thiolactone monomer by shifting the polymer-monomer equilibrium towards the monomer through the Thorpe-Ingold effect, thus establishing chemical circularity of c-P3T(Me)₂P (FIG. 1B). This gem-disubstitution effect has been successfully applied to several strained (thio) lactones to enable their corresponding poly(thio) esters chemically circular. Fourth, suppression or elimination of in-polymerization cyclization could be achieved by utilizing an exceptionally bulky (˜1.4 nm) phosphazene superbase, ^{t}Bu-P4 {[(Me₂N)₃P═N)]₃P═N (^{t}Bu)}, which is posited to effectively block the cyclization during the polymerization (FIG. 1C). However, when it is detached from the chain, simply triggered by a protic quenching reagent, such as H⁺/MeOH or MeOH at the end of polymerization, due to its high Brønsted basicity but relatively low nucleophilicity, spontaneous cyclization takes place to furnish the desired c-P3T(Me)₂P (FIG. 1C). Guided by the above four hypotheses, we achieved results, described as follows, demonstrating that, indeed, the ^{t}Bu-P4 mediated ROP of (Me)₂TPL selectively produces c-P3T(Me)₂P with UHMM (Mₙ=2.23 MDa), through the proposed macromolecular cyclization by a protic trigger, and it is fully recyclable to monomer.

### Results and Discussion

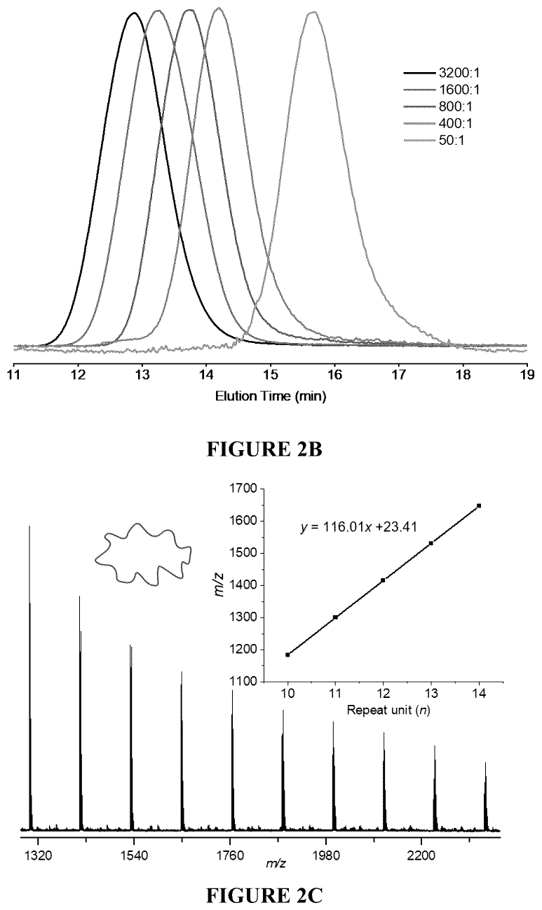

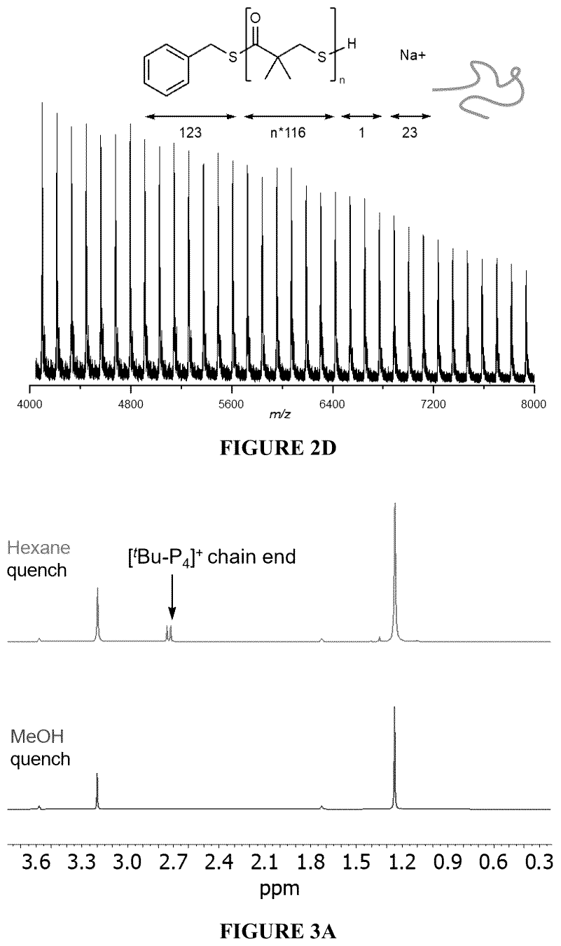

Organocatalyst-controlled topology P3T(Me)₂P. The monomer (Me)₂TPL can be synthesized in good yield via a two-step process from commercially available 3-chloropivalic acid or, more importantly, is obtainable in high yield (up to 95%) from NaOH-catalyzed bulk depolymerization of UHMM P3T(Me)₂P at 190° C. (vide infra). Initial polymerization screenings employed organic bases including superbases ^{t}Bu-P4, Et₃N, and 1,8-diazabicyclo[5.4.0]undec-7-ene (DBU) in tetrahydrofuran (THF) at 70° C. (Table 1). Polymerization runs with ^{t}Bu-P4 were conducted across a range of [(Me)₂TPL]:[^{t}Bu-P4] ratios from 200:1 to 3200:1. The size exclusion chromatography (SEC) analysis of the resulting polymers revealed a linear and proportional increase of molar mass (Mₙ=36.7-687 kDa) with the increase of the [(Me)₂TPL]:[^{t}Bu-P4] ratio, while the dispersity remained relatively narrow (Ð=1.27-1.31), evidencing a controlled polymerization (FIGS. 2A-2B). Impressively, the ROP of (Me)₂TPL by ^{t}Bu-P4 at a ratio of 6400:1 afforded UHMM P3T(Me)₂P (Mₙ=2.23 MDa, Ð=1.34). Matrix-assisted laser desorption/ionization time-of-flight mass spectroscopy (MALDI-TOF MS) analysis of the low-molar-mass P3T(Me)₂P using [(Me)₂TPL]:[^{t}Bu-P₄]=50:1 showed a single series of molecular ion peaks corresponding to a repeating unit mass of 116 Da and no end groups, indicating the prospective formation of c-P3T(Me)₂P (FIG. 2C).

TABLE 1
Results of ROP of (Me)2TPL.

| | | | | Time | Conv. | MALDI | Mₙ ^{c} | Ð ^{c} |
|---|---|---|---|---|---|---|---|---|
| Run ^{a} | Catalyst | Initiator | [M]:[Cat.]:[I] | (h) | (%) ^{b} | result | (kDa) | (M_{w}/Mₙ) |
| 1 | ^{t}Bu-P₄ | — | 50:1 | 4 | 100 | Cyclic | 9.1 | 1.43 |
| 2 | ^{t}Bu-P₄ | — | 200:1 | 4 | 100 | n.d. | 36.7 | 1.27 |
| 3 | ^{t}Bu-P₄ | — | 400:1 | 4 | 100 | n.d. | 77.5 | 1.31 |
| 4 | ^{t}Bu-P₄ | — | 800:1 | 4 | 100 | n.d. | 166 | 1.29 |
| 5 | ^{t}Bu-P₄ | — | 1600:1 | 4 | 100 | n.d. | 347 | 1.28 |
| 6 | ^{t}Bu-P₄ | — | 3200:1 | 10 | 100 | n.d | 687 | 1.30 |
| 7 | ^{t}Bu-P₄ | — | 6400:1 | 10 | 85 | n.d | 2226 | 1.34 |
| 8 | ^{t}Bu-P₄ | BnOH | 50:1:1 | 1 | 100 | Cyclic | 11.1 | 1.21 |
| 9 | ^{t}Bu-P₄ | BnSH | 50:1:1 | 12 | 100 | Mixture | 7.4 | 1.23 |
| 10 | Et₃N | BnSH | 50:1:1 | 48 | 100 | Linear | 7.2 | 1.37 |
| 11 | Et₃N | BnSH | 200:1:1 | 96 | 86 | n.d. | 18.4 | 1.25 |
| 12 | DBU | BnSH | 50:1:1 | 4 | 100 | Linear | 6.4 | 1.33 |
| 13 | DBU | BnSH | 100:1:1 | 12 | 100 | n.d. | 13.8 | 1.34 |
| 14 | DBU | BnSH | 200:1:1 | 12 | 100 | n.d. | 24.4 | 1.49 |
| 15 | DBU | BnSH | 400:1:1 | 12 | 100 | n.d. | 51.8 | 1.43 |
| 16 | DBU | BnSH | 800:1:1 | 36 | 92 | n.d | 82.4 | 1.44 |
| 17 | DBU | BnSH | 1600:1:1 | 36 | 69 | n.d. | 129 | 1.35 |

^{a} Conditions: (Me)₂TPL (1.0 mmol), 70° C., THF (0.2 mL); n.d. = not determined.
^{b} Determined by ¹H NMR in CDCl₃.
^{c} Number-average molar mass (Mₙ) and dispersity index (Ð = M_{w}/Mₙ) determined by SEC at 40° C. in CHCl₃ coupled with a DAWN HELEOS II multi (18)-angle light scattering detector and an Optilab TrEX dRI detector for absolute molar mass.

To further characterize the topology of the proposed c-P3T(Me)₂P, we attempted to synthesize a linear analogue, l-P3T(Me)₂P, for comparative analysis. We proposed that substituting the initiating ^{t}Bu-P4 with a species of a lower propensity for displacement in the ring closing attack of the α-terminus by the anionic ω-terminus would suppress the formation of c-P3T(Me)₂P and result in the formation of l-P3T(Me)₂P. Additionally, an initiating species which does not electrostatically draw the termini into proximity and proceeds through an ion-paired or neutral, rather than zwitterionic, polymerization should further inhibit the formation of cyclic products. To this end, benzyl alcohol (BnOH) was employed as the co-initiator. Prior to monomer addition, BnOH was premixed with ^{t}Bu-P4 in a 1:1 ratio and stirred for 10 minutes to ensure formation of the corresponding benzyl alkoxide. MALDI-TOF MS analysis of the P3T(Me)₂P obtained from the [(Me)₂TPL]:[^{t}Bu-P4]:[BnOH]=50:1:1 ratio run produced a mass spectrum with the major peaks matching those of the P3T(Me)₂P produced by ^{t}Bu-P4 alone. Switching to the mercaptan equivalent (BnSH) resulted in a mixture of different end groups. We therefore opted for a weaker nucleophilic base (Et₃N) that would not compete with BnSH for initiation of the ROP of (Me)₂TPL with [(Me)₂TPL]:[Et₃N]:[BnSH]=50:1:1 and satisfyingly observed the formation of l-P3T(Me)₂P (Mₙ=7.2 kDa, Ð=1.37) with a single end group set corresponding to the mass of BnSH. However, the rate of polymerization (86% conversion after 96 h, [(Me)₂TPL]:[Et₃N]:[BnSH]=200:1:1) proved too slow for the efficient synthesis of high molar mass samples. This is most likely a result of an equilibrium proton exchange between the active anionic chain end and Et₃N—H⁺, thus impeding the rate of propagation. In light of this reasoning, the stronger base DBU was employed. Quantitative monomer conversion was achieved within 12 h with [(Me)₂TPL]:[DBU]:[BnSH]=200:1:1, corresponding to a greater than 8× increase in rate relative to the Et₃N runs. MALDI-TOF MS analysis of the P3T(Me)₂P (Mₙ=6.4 kDa, Ð=1.33) obtained from a run with [(Me)₂TPL]:[DBU]:[BnSH]=50:1:1 confirmed the linear topology with a single end group set corresponding to the mass of BnSH (FIG. 2D). The control of the DBU/BnSH polymerization was confirmed by SEC analysis across a range of initiator loadings from [(Me)₂TPL]:[DBU]:[BnSH]=50:1:1 to 200:1:1, which revealed a linear and proportional relationship between molar mass and the [(Me)₂TPL]:[BnSH] ratio, while the dispersity of the resulting linear P3T(Me)₂P remained relatively narrow (1.33-1.49). Lowering the DBU catalyst loading to 0.06 mol % ([(Me)₂TPL]:[DBU]:[BnSH]=1600:1:1), a high molar mass l-P3T(Me)₂P (129 kDa, Ð=1.35) was afforded. Having achieved the synthetic route to l-P3T(Me)₂P, analogous c- and l-P3T(Me)₂P were subsequently synthesized by their respective initiating system (^{t}Bu-P4 and DBU/BnSH) with similar molar mass and dispersity values (c-P3T(Me)₂P: Mₙ=16.0 kDa, Ð=1.35; l-P3T(Me)₂P: Mₙ=17.1 kDa, Ð=1.60). A Mark-Houwink-Sakurada plots (i.e., double logarithmic plots of intrinsic viscosity ([η]) versus weight-average molar mass (M_{w}) determined by light scattering detection) confirmed the c-P3T(Me)₂P exhibited a lower [η] than its linear counterpart, further supporting the topological assignments.

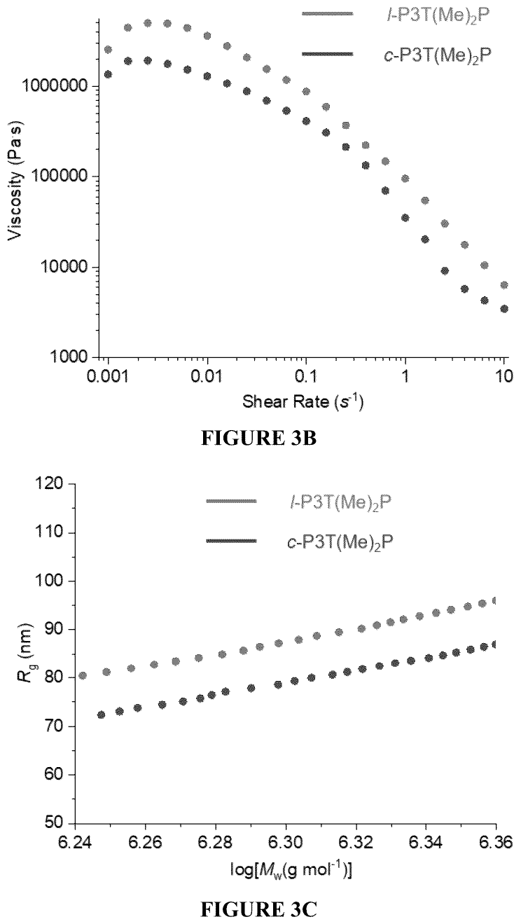

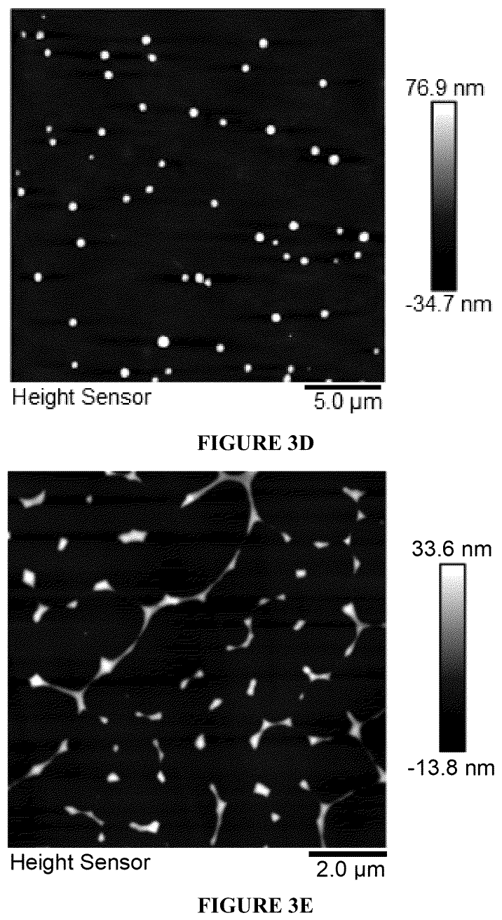

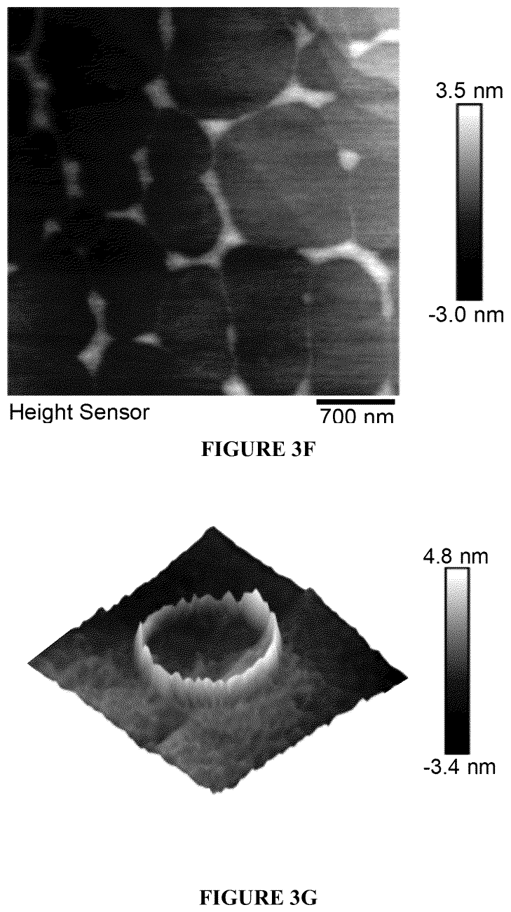

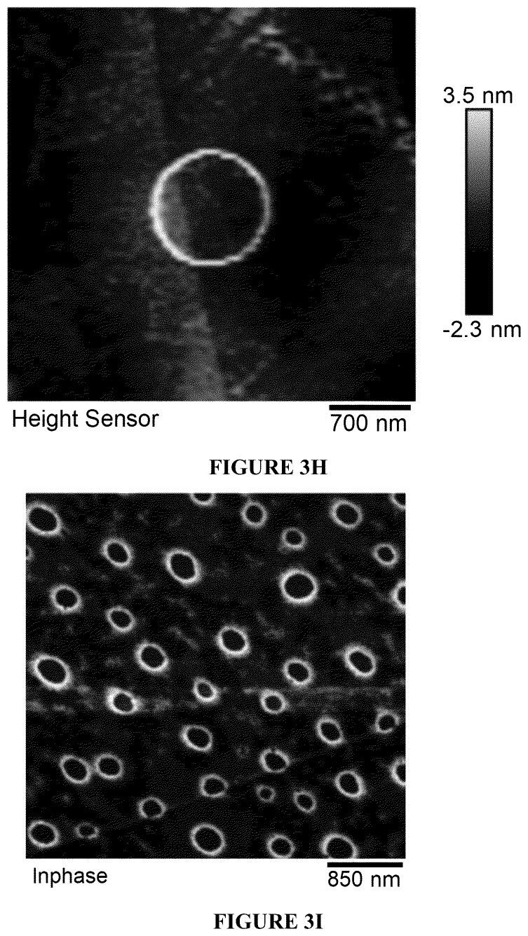

Controlling the topology by different quenching methods. The above observed excellent selectivity, control over molar mass, and narrow dispersity for the synthesized c-P3T(Me)₂P led to a hypothesis that the chain cyclization event occurs after complete conversion of monomer. Two plausible explanations could account for this scenario, the first being that the mechanism of cyclization is available throughout the polymerization reaction, but the rate of this event is too slow to compete with propagation. Alternatively, the cyclization pathway is inaccessible prior to full monomer conversion and addition of an external trigger such as the protic quench or workup that catalyzes the topological transformation. We produced the following four lines of evidence that is consistent with the latter scenario. First, the rate of polymerization was not observed to be particularly fast and several runs which were analyzed prior to complete monomer conversion possessed also narrow dispersity and cyclic topology after the protic quench. Second, ¹H NMR (THF-d₈) analysis of the polymer sample obtained from quenching the polymerization with [(Me)₂TPL]:[^{t}Bu-P4]=50:1 in a non-protic solvent such as hexane clearly revealed the ^{t}Bu-P₄ chain-end (FIG. 3A). This chain-end evidence revealed by ¹H NMR was further corroborated by ¹³P NMR spectra that showed the ^{t}Bu-P₄ chain end is well located on the polymer chain quenched in hexane, supporting a linear topology without cyclization. Third, in contrast, no chain end was observed in the polymer sample quenched with protic MeOH or acidified MeOH (FIG. 3A). Note that, to exclude the potential interference of the possibly consumed initiator ^{t}Bu-P₄, all isolated polymers prior to NMR analyses were precipitated twice in hexane or methanol and dried.

This unique, selective, and convenient quenching method for topological transformation enabled us to synthesize both UHMM linear and cyclic polymers in parallel. Specifically, we carried out polymerization runs with [(Me)₂TPL]:[^{t}Bu-P₄]=6400:1 in parallel reaction vessels and terminated both reactions simultaneously via precipitation into two different solvents, non-protic hexane and protic methanol, respectively yielding similar molar mass l-P3T(Me)₂P (Mₙ=2.17 MDa, Ð)=1.26) and c-P3T(Me)₂P (Mₙ=2.23 MDa, Ð=1.34). It is worth mentioning these molar masses were determined absolutely via the use of dn/dc values obtained independently for both l- and c-P3T(Me)₂P samples. As is consistent with literature precedent, the dn/dc of l-P3T(Me)₂P (0.1171 mL g⁻¹) was higher than that of its cyclic analogue (0.1107 mL g⁻¹). These samples were further characterized and compared through analysis of their [η] and bulk rheological viscosity η. As expected, c-P3T(Me)₂P had lower η and [η] (FIG. 3B) as cyclic polymers have a lower degree of chain entanglement. Comparing the M_{w} per elution volume (as functions of hydrodynamic radius), it was found that c-P3T(Me)₂P on average had M_{w} a factor of 1.58 times higher than l-P3T(Me)₂P. Additionally, the radius of gyration (R_{g}) was measured through multiangle light scattering and compared between the linear and cyclic polymers. To measure the mean square radius of gyration ratio more accurately, we first synthesized l-P3T(Me)₂P (Mₙ=2.17 MDa) through quenching in hexanes; it was then redissolved in dichloromethane and precipitated in methanol to obtain c-P3T(Me)₂P (Mₙ=2.22 MDa). The c/l R_{g}-ratio was found to be 0.84 for these UHMM polymers (FIG. 3C) and decreased to 0.71 for much lower molar mass samples: c-P3T(Me)₂P, Mₙ=18.0 kDa; l-P3T(Me)₂P, Mₙ=18.5 kDa. This observed effect of molar mass on the R_{g} ratio was reasoned that the longer the chains, the lower the differences in rheology and viscosity between cyclic and linear chains, especially in the UHMM region (the model of an infinite linear chain is just that of the cyclic chain). AFM microscopy was selected as the preferred imaging technique, as this method of direct imaging does not require additional modification of polymer chains by way of post-polymerization functionalization or staining typically required for observation. Thus, owing to its sulfur-containing and UHMM, direct visualization of the cyclic topology became possible by AFM, which was employed to directly image the UHMM c-P3T(Me)₂P sample, revealing rings of on-average ˜517 nm in diameter and again directly supports the cyclic topological assignment (FIG. 3D). At the same time, UHMM l-P3T(Me)₂P showed completely different, linear morphology through characterization by AFM (FIG. 3E). However, the conditions employed for sample preparation (1.0 mg/mL concentration and 2000 rpm spin coating speed) yielded polymer aggregates as indicated by the height of ˜77 nm for c-P3T(Me)₂P and ˜34 nm for l-P3T(Me)₂P. To reduce or suppress polymer aggregation, we reduced the polymer concentration to 0.01 mg/mL and increased the speed of spin coating to 4000 rpm. Gratifyingly, the resulting AFM images of both cyclic and linear polymers showed a much-reduced height to only about 3.5 nm for c-P3T(Me)₂P and l-P3T(Me)₂P (FIGS. 3F-3I), which is consistent with the height scale for single polymer chains. Overall, coupled with the above described MALDI-TOF-MS, NMR, and SEC results, the collective AFM images fully support our topological assignments, both directly through the observation of aggregate and single chains.

The above results fully support the linear and cyclic structures of UHMM P3T(Me)₂P initiated by ^{t}Bu-P₄ and quenched with non-protic hexane or protic MeOH, respectively, and demonstrate that the protic quench is the key step in enabling the linear-to-cyclic topological transformation. The results and above-described reasonings led to a proposed mechanism, shown in FIG. 1C, that the protic quench triggers the ring closing cyclization event and subsequent displacement of the initiating ^{t}Bu-P₄ end group. The inability of the propagating zwitterionic P₄⁺—S⁻ species to cyclize during polymerization can be attributed to the exceptionally steric hindrance of the P₄⁺ (˜1.4 nm) that effectively blocks intramolecular nucleophilic attack by the terminal sulfide anion S⁻ and poor leaving nature of ^{t}Bu-P4. The same reasoning applies to the post-polymerization quench with hexane. In contrast, quenching with MeOH provides a protic source that triggers the cyclization, as ^{t}Bu-P4 is a superbase that favors the abstraction of proton from MeOH to ^{t}Bu-P₄, yielding [P₄H]⁺[OMe]⁻, causing detachment of the P₄ from the chain and concomitant ring-closure (FIG. 1C). Considering that an equilibrium for potential proton exchange between the sulfide and methoxide anions should lie far to the MeOH+sulfide since the pKₐ of methyl mercaptan (10.4) is much smaller than that of methanol (24.0), there should be mainly sulfide anions in the system upon addition of MeOH. Regarding the observed apparently exclusive selectivity for the intramolecular cyclization over the possible competing intermolecular coupling, we posit that it is due to the combination of the ionic interactions between the termini of the zwitterionic polymer chain and favored entropy for cyclization via intramolecular ion pairing as the coupling of two polymer chains via intermolecular ion pairing further reduces the total number of microstates (i.e., the loss of translational freedom) by a greater amount than cyclization does.

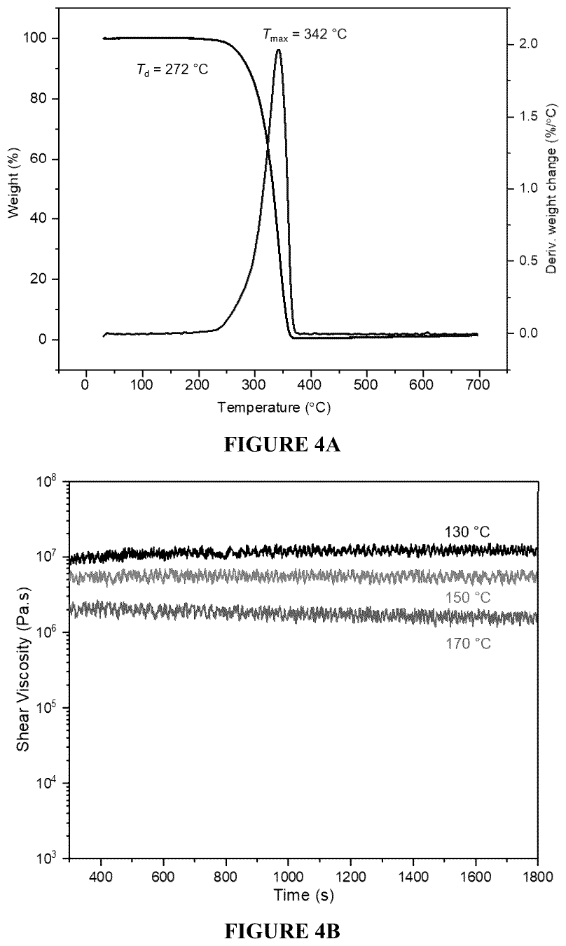

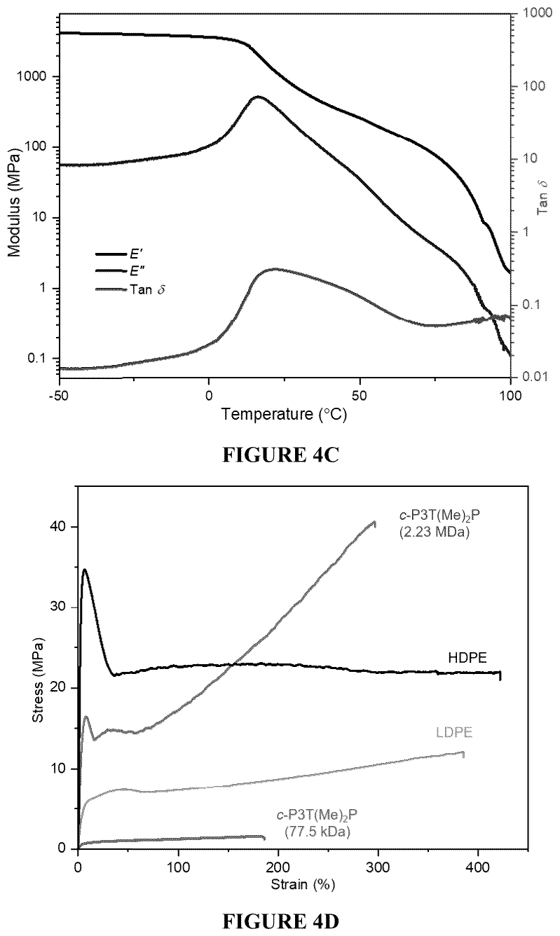

Thermal, rheological, and mechanical properties. Thermal properties of UHMM c-P3T(Me)₂P (Mₙ=2.23 MDa) were first characterized using differential scanning calorimetry (DSC) and thermogravimetric analysis (TGA). Despite having a moderate melting-transition temperature (Tₘ) of 76/83° C. (from 1^{st} heating scan; not observable on the 2^{nd} heating scan) and glass-transition temperature (T_{g}) of −1.1° C. (from 2nd heating scan; unclear on the 1st heating scan) for c-P3T(Me)₂P, it exhibited higher degradation temperature (T_{d}) (the temperature at 5% weight loss) value of 272° C. and maximum rate decomposition temperatures (Tₘₐₓ) of 342° C. (FIG. 4A) compared to that of c-P3 TB without the dimethyl substituents (T_{d}=198° C.). This 74° C. increase in T_{d} can be attributed to the absence of α-hydrogens that promote cis-elimination at high temperatures and leads to a larger processing window (difference between Tₘ and T_{d}) of 191° C. Although the topology and molar mass (within the current high molecular region from 129 kDa to 2.23 MDa) were found to have a little effect on Tₘ, topology showed a greater effect on T_{d}. The T_{d} of l-P3T(Me)₂P (Mₙ=2.17 MDa) decreased by 14° C. to a lower T_{d} of 258° C., attributable to the present of chain ends. Thermal stability of UHMM c-P3T(Me)₂P was further evaluated by examining its melt-processability through shear viscosity measurements over a period of 30 min at a fixed shear rate and under continuous-flow mode. The shear viscosity remained constant without any obvious decrease at 130 or 150° C., but at 170° C. there was a slight drop in shear viscosity after 30 min (FIG. 4B), which may indicate its upper limit of the processing temperature.

Thermomechanical properties were examined by dynamic mechanical analysis (DMA), which revealed a high storage modulus (E′) value of 3.66 GPa at 0° C. (the glassy state) and a drop in E′ after the glass transition region with an a transition temperature of ˜20° C., as defined by the peak maxima of tan δ [the loss modulus/storage modulus ratio (E″/E′)] (FIG. 4C). Uniaxial tensile testing of dog-bone-shaped specimens of UHMM c-P3T(Me)₂P (Mₙ=2.23 MDa), which were compression-molded via hot pressing at 150° C., followed by slow cooling and annealing at room temperature for 24 h, revealed a high ultimate strength (σ) of 39.3±2.9 MPa, a good elongation at break (ε_{b}) of 282±14%, and an elastic modulus (E) of 0.51±0.08 GPa, giving rise to a high toughness of U_{T}=66±6 MJ m⁻³ (Table 2). These results were obtained from twice-recycled (reprocessed) specimens prepared by compression molding, demonstrating excellent reprocessability. When compared with low-density polyethylene (LDPE) and high-density polyethylene (HDPE) standards employed for comparison, the UHMM c-P3T(Me)₂P showed similar ductility but much greater ultimate stress due to its pronounced strain hardening (FIG. 4D). Effects of molar mass on the mechanical performance of c-P3T(Me)₂P are evident as the polymer with a medium molar mass of Mₙ=77.5 kDa (Ð=1.31) is only a soft elastomer with elastic stress σ below 1.6 MPa and without a yield point (FIG. 4D). Lastly, transmittance and reflectance properties of UHMM c-P3T(Me)₂P were analyzed using an ultraviolet-visible near infrared spectrophotometer. The analysis showed that this polymer is optically clear, with a transmittance value (T %) of 84% and a reflectance value of 9.0% in the visible range (350-800 nm). Compared to other commercially available materials, this UHMM cyclic polymer is as good as a one-gallon Ziploc bag (LDPE, T %=89%), and far superior to highly crystalline isotactic poly(3-hydroxybutyrate) (T %=19%). Lastly, these properties of UHMM c-P3T(Me)₂P were also compared with those of UHMM l-P3T(Me)₂P. Prior to testing, the topological stability of the zwitterionic l-P3T(Me)₂P under processing conditions (hot press at 150° C. for 15 min) was verified by observing no change in the integration ratio of the relevant ¹H NMR peaks of the P4 chain-end to polymer main-chain before and after the processing. The test results showed that UHMM c-P3T(Me)₂P (Mₙ=2.23 MDa, Ð=1.34) exhibits similar properties to l-P3T(Me)₂P (Mₙ=2.01 MDa, Ð=1.35) in transmittance, reflectance, and elongation at break, but c-P3T(Me)₂P displays higher storage and loss moduli in the glassy state by DMA and higher yield stress and ultimate strength by tensile testing (Table 3).

TABLE 2
Tensile testing data for c-P3T(Me)₂P (Mₙ = 2.23 MDa, Ð = 1.34).

| | Stress | Strain | Modulus | Toughness |
|---|---|---|---|---|
| Entry | (MPa) | (%) | (GPa) | (MJ m⁻³) |
| 1 | 35.9 | 270 | 0.46 | 59 |
| 2 | 40.6 | 298 | 0.47 | 71 |
| 3 | 41.3 | 279 | 0.60 | 69 |
| Average | 39.3 | 282 | 0.51 | 66 |
| Standard | 2.9 | 14 | 0.08 | 6 |
| deviation | | | | |

TABLE 3
Tensile testing data for l-P3T(Me)₂P (Mₙ = 2.01 MDa, Ð = 1.35).

| | Stress | Strain | Modulus | Toughness |
|---|---|---|---|---|
| Entry | (MPa) | (%) | (GPa) | (MJ m⁻³) |
| 1 | 35.2 | 281 | 0.41 | 61 |
| 2 | 35.1 | 296 | 0.44 | 66 |
| 3 | 35.2 | 309 | 0.36 | 59 |
| Average | 35.2 | 295 | 0.40 | 62 |
| Standard | 0.02 | 14 | 0.04 | 4 |
| deviation | | | | |

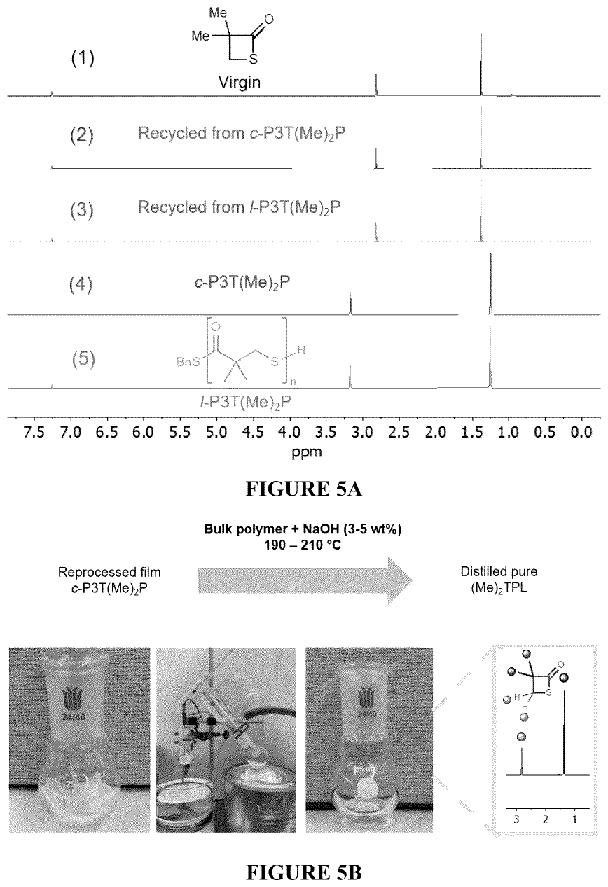

Chemical circularity of c-P3T(Me)₂P. The prospect of chemical recycling to monomer towards establishing a closed-loop lifecycle for c-P3T(Me)₂P was investigated by chemically catalyzed thermolysis or chemolysis (Table 4). Heating c-P3T(Me)₂P (Mₙ=36.7 kDa, Ð=1.27), obtained with [(Me)₂TPL]:[^{t}Bu-P4]=200:1, mixed with 5 wt % NaOH at 190° C. for 6 h under solvent-free, vacuum (˜0.2 Torr) conditions distilled off pure thiolactone monomer (Me)₂TPL in 90% isolated yield (FIG. 5A (2)). Likewise, a l-P3T(Me)₂P sample (Mₙ=24.4 kDa, Ð=1.49) was also effectively depolymerized under the same conditions to recover pure (Me)₂TPL in 91% isolated yield (FIG. 5A (3)). Furthermore, the ceiling temperature (T_{c}) of c-P3T(Me)₂P was determined by measuring equilibrium monomer concentration [(Me)₂TPL]_{eq} at different temperatures through a variable-temperature NMR study using a ratio of [(Me)₂TPL]:[^{t}Bu-P4]=100:1 at [(Me)₂TPL]₀=0.1 mol L⁻¹ in toluene-d₈. The Van't Hoff plot of In[(Me)₂TPL]_{eq} VS. 1/T from this experiment gave a straight line, from which standard-state thermodynamic parameters were calculated: the enthalpy change (ΔHo p)=−34.4 KJ·mol⁻¹ and the entropy change of polymerization (ΔSo p)=−60.9 J·mol⁻¹·K⁻¹. On the basis of the equation T_{c}=ΔHo p/{ΔSo p+Rln[(Me)₂TPL]₀}, T_{c} was calculated to be 298° C. when extrapolated to [(Me)₂TPL]₀=1.0 mol L⁻¹. Owing to the dynamic nature of thioester bonds promoting the equilibrium to shift towards the monomer state under catalysis and vacuum, catalyzed depolymerization can be carried out at a much lower temperature of 190° C., with continuous removal of the reformed monomer using a vacuum distillation setup (FIG. 5B).

TABLE 4
Results of depolymerization of P3T(Me)²P.

| | | | Scale | | | | |
|---|---|---|---|---|---|---|---|
| | | | of | Catalyst | | | |
| | | | poly- | (NaOH) | | | Recovered |
| | | Mₙ | mer | loading | Temp. | Time | monomer ^{b} |
| Run ª | Polymer | (kDa) | (g) | (wt %) | (° C.) | (h) | (%) |
| 1 | l-P3T(Me)₂P | 24.4 | 0.1 | 5 | 190 | 6 | 91 |
| 2 | c-P3T(Me)₂P | 36.7 | 0.1 | 5 | 190 | 6 | 90 |
| 3 | c-P3T(Me)₂P | 77.5 | 1.3 | 5 | 190 | 6 | 88 |
| 4 | c-P3T(Me)₂P | 2226 | 1.4 | 3 | 210 | 10 | 95 |

^{a} Conditions: P3T(Me)₂P, depolymerized with a vacuum distillation setup (~0.2 Torr).
^{b} Isolated monomer yield.

The above depolymerization results employed a precipitated powder sample prior to processing. To simulate a sample that has completed a real-world application use cycle, dog-bone-shaped specimens that had undergone mechanical testing were directly depolymerized in the presence of a catalyst (3 wt % solid NaOH). Thus, when using the reprocessed c-P3T(Me)₂P film material (Mₙ=77.5 kDa, Ð=1.31), (Me)₂TPL was distilled off under vacuum at 190° C., obtaining the pure monomer in 88% isolated yield (FIG. 5B). Notably, when performing depolymerization on a UHMM cyclic P3T(Me)₂P film (1.40 g, Mₙ=2.23 MDa, Ð=1.34) with 3 wt % NaOH at 210° C. under vacuum, pure (Me)₂TPL was collected in a total yield of 95%.

Worth noting also is that, when the recovered (Me)₂TPL was subjected to repolymerization through the ^{t}Bu-P4 mediated ROP ([(Me)₂TPL]:[^{t}Bu-P4]=6400:1) at 70° C., UHMM cyclic c-P3T(Me)₂P was again obtained, achieving a similar Mₙ (2.09 MDa, Ð=1.39) to that of the virgin polymer synthesized from the staring (Me)₂TPL monomer. Comparative thermal (uncatalyzed) depolymerizations of l-P3T(Me)₂P (Mₙ=2.17 MDa, Ð=1.26) and c-P3T(Me)₂P (Mₙ=2.23 MDa, Ð=1.34) at 210° C., ˜0.2 Torr and fixed time (12 h) revealed that the monomer recovery yield from the linear polymer (85%) is more than twice that from the cyclic counterpart (40%). This result is expected as the linear polymer has chain ends, which allow for depolymerization via chain “unzipping” initiated by the chain-end nucleophiles, whereas the depolymerization of cyclic polymer relies on spontaneous chain scission. Overall, the above results demonstrated the expedient chemical circularity of c-P3T(Me)₂P and the distinctive topology-dependent depolymerization phenomenon, primarily dictated by the concentration of polymer chain-end nucleophiles that facilitate depolymerization through the proposed chain “unzipping” process.

### CONCLUSION

In summary, we introduced a simple, selective method for the synthesis of UHMM (>2 MDa) linear or cyclic polymers, simply by quenching the polymerization reaction with non-protic hexane or protic methanol, while all other reactions conditions and reagents are identical. In essence, we developed a synthetic methodology that allows for the synthesis of cyclic polymers with the same degree of control, ease, designability as for the synthesis of linear polymers.

In the representative ROP of thiolactone (Me)₂TPL described herein in detail, the ROP initiated by superbase ^{t}Bu-P4 yields either UHMM l-P3T(Me)₂P (Mₙ=2.17 MDa, Ð=1.26) when quenched in hexane, or UHMM c-P3T(Me)₂P (Mₙ=2.23 MDa, Ð=1.34) when quenched in methanol. Uniquely, in-polymerization macromolecular cyclization, which is challenging to suppress or eliminate in conventional methods for cyclic polymer synthesis, does not occur during the polymerization or post-polymerization quench with non-protic hexane but, desirably, it occurs instantaneously when quenching the reaction with protic methanol. This unique cyclization mechanism by a protic trigger on demand enabled selective and controlled synthesis of cyclic polymers, just like the way the linear analogs are synthesized, but just with a different quenching reagent or solvent. In addition, the combination of UHMM and sulfur content in c-P3T(Me)₂P allowed for direct visualization by AFM without the need for post-polymerization functionalization, whereas UHMM endows much enhanced thermostability and mechanical toughness. Furthermore, owing to its gem-disubstitution this UHMM cyclic (or linear) polymer can be quantitatively recycled back to monomer under mild conditions, establishing a circular lifecycle for cyclic polythioester.

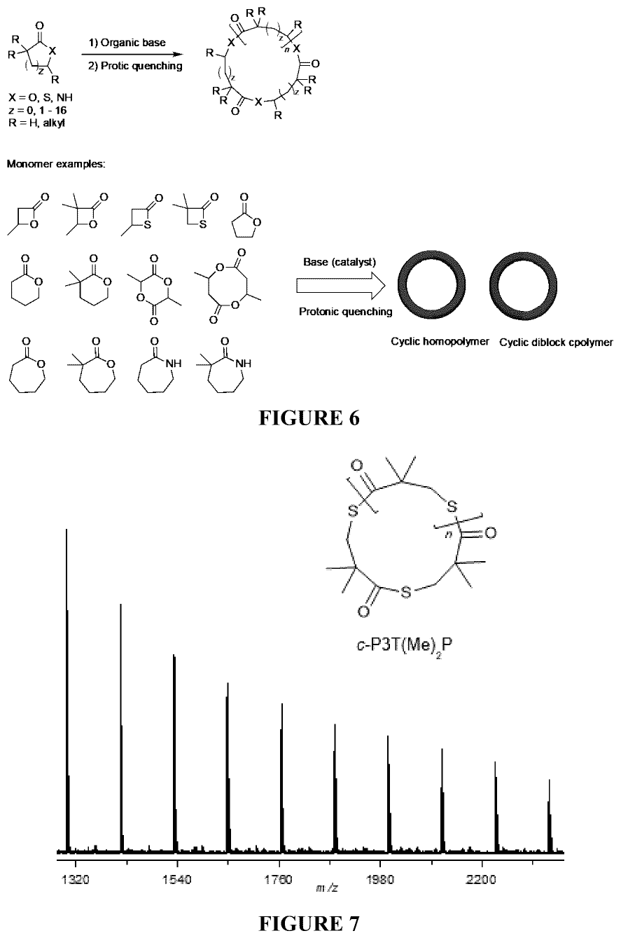

Our preliminary results also suggest this simple method can be applied to other polymer types. Specifically, our preliminary results suggest that this methodology is applicable to the polymerization of other heterocyclic monomers such as lactones, thiolactones, lactides, diolides, lactams et al., as well as their mono- and germinal disubstituted derivatives, for the production of their corresponding cyclic homopolymers, cyclic diblock copolymers, and cyclic triblock copolymers (FIG. 6).

### Materials and Methods

General Considerations. All syntheses and manipulations of air- and moisture-sensitive materials were carried out in flamed Schlenk-type glassware on a dual-manifold Schlenk line or in an inert gas (N₂)-filled glovebox. High-performance liquid chromatography (HPLC)-grade organic solvents were first sparged extensively with nitrogen during filling 20 L solvent reservoirs and then dried by passage through activated alumina (for tetrahydrofuran (THF) and dichloromethane (DCM)) followed by passage through Q-5 supported copper catalyst (for toluene and hexanes) stainless steel columns. For the THF used in polymerization reactions, HPLC-grade THF was degassed and dried over sodium and benzophenone for 12 h, followed by vacuum distillation.

Materials. ^{t}Bu-P₄ (0.8 M in hexane) was purchased from Sigma-Aldrich Chemical Co. and used in a glovebox as received. Benzyl alcohol (BnOH) and 1,8-diazabicyclo[5.4.0]undec-7-ene (DBU) were purchased from Fisher Scientific Co. and Sigma-Aldrich Chemical Co., respectively, and purified by distillation over CaH₂ and stored over activated Davison 4 Å molecular sieves. Benzyl mercaptan (BnSH) was purchased from TCI Chemical Co. and used in the glovebox as received. Sodium hydrosulfide hydrate, triethylamine, and isobutyl chloroformate were purchased from Oakwood Chemical Co., sodium hydroxide was purchased from Fisher Scientific Co., and all were used in the glovebox as received. 3-Chloropivalic acid was purchased from TCI Chemical Co. Low-density polyethylene (LDPE, 3-4 mm granules, melt flow index (MFI)=7.5) and high-density polyethylene (HDPE, 2-4 mm granules, MFI=7.6) were purchased from Sigma-Aldrich and Goodfellow, respectively. One-gallon Ziploc bag was purchased from Walmart and tested as purchased. Bacterial it-P3HB (Mₙ=550 kDa, 5 mm granules, Product Code BU39-GL-000111) was purchased from Goodfellow.

### Instruments and Characterizations

Nuclear magnetic resonance (NMR) analysis. NMR spectrum were recorded on a Varian Inova or Bruker AV-III 400 MHz spectrometer (400 MHz, 1H; 100 MHz, ¹³C) at 298 K. Chemical shifts (δ) are reported in ppm with the solvent resonance employed as the internal standard (chloroform-d₁ at 7.26 ppm for ¹H-NMR and 77.0 ppm for ¹³C NMR; THF-d₈ at 3.58 ppm for ¹H NMR; dichloromethane-d₂ at 5.30 ppm for ¹H NMR). Signals are reported as integration, multiplicity (s=singlet, d=doublet, t=triplet), coupling constant(s) in Hz, assignment.

Absolute molar mass measurements by size exclusion chromatography (SEC). Measurements of polymer absolute M_{w}, Mₙ, and Ð values were performed by SEC on an Agilent HPLC system equipped with one guard column and two PLgel 5 μm mixed-C gel permeation columns and coupled with a Wyatt DAWN HELEOS II multi (18)-angle light scattering detector and a Wyatt Optilab TrEX dRI detector; the analysis was performed at 40° C. using CHCl₃ as the eluent at a flow rate of 1.0 mL/min, using Wyatt ASTRA 7.1.2 molar mass characterization software. Viscometry experiments were performed in a similar way with the addition of a Wyatt Viscostar III viscometer. Polymer solutions were prepared in CHCl₃ and injected into dRI detector by Harvard Apparatus pump 11 at a flow rate of 0.2 mL/min. A series of known concentrations were injected and the change in refractive index was measured to obtain a plot of change in refractive index versus change in concentration ranging from 0.5 to 10.0 mg/mL. The slope from a linear fitting of the data was the dn/dc of the polymer: dn/dc=0.1171±0.0029 mL/g for l-P3T(Me)₂P; dn/dc=0.1107±0.0019 mL/g for c-P3T(Me)₂P.

Matrix-assisted laser desorption/ionization time-of-flight mass spectroscopy (MALDI-TOF MS). The experiment was performed on a Bruker Ultraflextreme mass spectrometer (Bruker Daltonics, Billerica, MA) operated in positive ion, reflector mode using a Nd:YAG laser at 355 nm and 20 kV accelerating voltage. A thin layer of a mixed solution (20 μL of 20 g/L trans-2-[3-(4-tert-butylphenyl)-2-methyl-2-propenylidene]malononitrile (DCTB) in THF, 3 μL of 10 g/L polymer sample, 1 μL of 22.1 g/L sodium trifluoroacetate (NaTFA)) was deposited on the target plate (ground steel). Polyethylene glycol (4 kDa) was used as the calibrant and prepared the same way as the polymer sample. The raw data was processed using FlexAnalysis (version 3.4.7, Bruker Daltonics).

Differential scanning calorimetry (DSC) and thermal gravimetric analysis (TGA). Melting transition (Tₘ) and glass transition (T_{g}) temperatures were measured by DSC on an Auto Q20, TA Instrument. All Tₘ and T_{g} values were obtained from the second scan unless indicated otherwise. Both heating rate and cooling rate were 10° C./min unless indicated otherwise. Decomposition temperatures (T_{d}) and maximum rate decomposition temperatures (Tₘₐₓ) of the polymers were measured by TGA on a Q50 TGA Analyzer, TA Instrument. Polymer samples were heated from ambient temperature to 700° C. at a heating rate of 10° C./min. Values of Tₘₐₓ were obtained from derivative thermogravimetric (DTG) curve: wt %/° C. vs. temperature (° C.) plots.

Mechanical analysis. Tensile stress/strain testing was performed by an Instron 5966 universal testing system (10 kN load cell) on dog-bone-shaped test specimens (ASTM D638 standard; Type V) prepared via compression molding using a Carver Bench Top Laboratory Press (Model 4386) equipped with a two-column hydraulic unit (Carver, Model 3912, maximum force 24000 psi) unless indicated otherwise. Isolated polymer materials were loaded between non-stick Teflon paper sheets into a stainless-steel mold with inset dimensions 30×73.5×0.38 mm fabricated inhouse and compressed between two 6″×6″ steel electrically heated platens clamp force 5000 psi, at temperature 10° C. higher than each material's respective Tₘ. Specimens for analysis were generated via compression molding and cut using an ASTM D638-5-IMP cutting die (Qualitest) to standard dimensions. Mechanical behavior was averaged for all the specimens measured for each individual species investigated. Thickness (0.38±0.01 mm), width (3.18 mm), and grip length (26.4±0.2 mm) of the measured dog-bone specimens were measured for normalization of data by the Bluehill measurement software (Instron). Test specimens were affixed into the screw-tight grip frame. Tensile stress and strain were measured to the point of material break at a grip extension speed of 5.0 mm min⁻¹ at ambient conditions. Testing of control standards of commercial HDPE and LDPE for comparative stress/strain curves included in FIG. 4D. The detailed tensile testing results (individual stress/strain curves and tables) were previously reported and the values were taken from that paper for comparison while plotting overlay FIG. 4D.

Rheology experiments. Shear viscosity measurements were performed on a Discovery Series HR-2 hybrid rheometer (TA Instruments) under nitrogen gas flow (30 psi). Test specimens were loaded between two 8 mm steel electrically heated platen (EHP) loading discs. Test specimens were trimmed at pre-determined temperatures above the Tₘ of respective polymers. The measurements were performed at gap lengths ˜600 μm and an experimental axial force of ˜0.2 N. The shear viscosity (in melt) over time experiment was performed under flow mode with a shear rate \dot{r}=0.01 s⁻¹ and a duration time of 1800 s.

Rheology-viscosity experiments. Viscosity experiments by rheology were performed on thoroughly dried linear and cyclic polymers prepared by heated compression molding at 150° C. (between two steel plates, a 38.1×12.7×1 mm steel mold, and non-stick Teflon sheets) inside a Carver Bench Top Laboratory Press (Model 4386). A Small circular-cut (8 mm diameter) samples were loaded between two 8 mm steel S6 electrically heated platen (EHP) loading discs within a Discovery Series HR-2 (Hybrid Rheometer) (TA Instruments) under nitrogen gas flow (30 psi) connected to the TRIOS software (TA Instruments). Viscosity was studied under the flow testing option and amplitude setting. Experiments were run at 150° C. with shear rates varying between 10⁻³ and 10 rad/s. The axial force was controlled within a negligible±0.1 N to prevent non-frictional forces.

Atomic force microscope (AFM). AFM images were obtained under ambient conditions using a Bruker Bioscope Resolve AFM in Peak Force Tapping Scanasyst mode. Silicon cantilevers (SCANASYST-AIR, spring force constant: 0.12 N/m, frequency: 23 kHz) were used. The samples were prepared under ambient conditions by spin coating (2000 or 4000 rpm, 30 s) freshly cleaved sheets (5 mm²) of highly ordered pyrolytic graphite (HOPG) with 10 μL of thoroughly dissolved polymer samples (1 or 0.01 mg/mL in toluene).

Dynamic mechanic analysis (DMA). Storage modulus (E′), loss modulus (E″), and tan δ (E″/E′) were measured on a Q800 DMA Analyzer (TA Instruments) in a tension film mode at a maximum strain of 0.05% and a frequency of 1 Hz (complying with strain-sweep and frequency-sweep linearity analysis performed prior to sample testing). Specimens for analysis were generated via compression molding and cut down to a standard width (13 mm). Specimen length (5-10 mm) and thickness (0.85±0.01 mm) were measured for normalization of data by Q-series measurement software (TA Instruments). Test specimens were mounted to screw-tight grips (maximum 2 N). The samples were heated from −50° C. to 100° C. at a heating rate of 3° C. min⁻¹. The α-transition temperature was calculated as the peak maxima of the tan δ curve. Samples were tested to the point of yield (amplitude of displacement >20 mm) with measurements repeated for 3 specimens, the values reported are averaged from the measured data.

UV-Vis-NIR optical property measurements. A Cary 5000 UV-vis NIR spectrophotometer from Agilent was used to measure the optical properties of thin films that were acquired by solvent casting from a suitable solvent. The films were cast in circular Teflon petri dish with a diameter of 6.5 cm. Film thickness was measured to be 0.02=0.01 mm. Films were acquired by solvent casting from an appropriate solvent which was allowed to evaporate overnight, covered by tin foil with small holes to allow for slow evaporation, before testing.

Procedures for the synthesis of l- and c-P3T(Me)₂P. The ROP reactions were performed in 10 mL Schlenk flasks or in 5.5 mL glass reactors inside an inert glovebox at ambient temperature (˜23° C.). A predetermined amount of (Me)₂TPL was added to a base catalyst solution in THE, or to a mixture of base catalyst and alcohol initiator in THF (as indicated in the polymerization tables) which was stirred at ambient temperature for 10 min before addition of monomer. The sealed reactors were taken out of the glove box and stirred at 70° C. After a desired period, a graduate change in viscosity was observed, and an aliquot was taken from the reaction mixture and prepared for ¹H NMR analysis to obtain the percent monomer conversion data. For reactions with [DBU]:[BnSH] to obtain linear polymer, the polymerization was quenched by addition of benzoic acid in chloroform (5 mg/mL), followed by precipitation in excess methanol 2-3 times. For the reactions with ^{t}Bu-P4 to obtain l-P3T(Me)₂P, the polymerization was precipitated in excess hexane 2-3 times. For reactions with ^{t}Bu-P4 to obtain c-P3T(Me)₂P, the polymerization was quenched by addition of benzoic acid in chloroform (5 mg/mL) and precipitated in excess methanol 2-3 times, or directly precipitated into methanol without addition of benzoic acid in chloroform. All precipitated polymers were then isolated by filtration, and the white polymer solid was dried in a vacuum oven at 60° C. to a constant weight.

Chemical recycling to lactone monomers (Me)₂TPL and repolymerization For freshly precipitated c- or l-P3T(Me)₂P: To a 5.5 mL glass reactor with a stir bar was added NaOH (5.0 mg, 5 wt %) and c- or l-P3T(Me)₂P (0.116 g, 1 mmol) obtained with a [(Me)₂TPL]:[^{t}Bu-P4] ratio of 200:1 or [(Me)₂TPL]:[DBU]:[BnSH] ratio of 200:1:1. The mixture was heated at 190° C. (oil bath) and the reformed monomer was distilled off under vacuum (˜0.2 Torr) with a receiving flask cooled to −78° C. (dry ice/acetone). After the polymer solid disappeared (about 6 h), the vacuum was turned off, and the cold bath was removed. As the flask was warmed to room temperature, a liquid was obtained, which was confirmed to be the recycled, pure monomer (Me)₂TPL by ¹H NMR analysis; 90-91% isolated yields.

For a reprocessed film of c-P3T(Me)₂P (Mₙ=77.5 kDa, Ð=1.31; cut into small pieces with scissors): To a 25 mL flask with a stir bar was added NaOH (39 mg, 5 wt %) and c-P3T(Me)₂P (1.30 g, 11.2 mmol) obtained with a [(Me)₂TPL]:[^{t}Bu-P4] ratio of 400:1. The mixture was heated at 190° C. (oil bath) and the reformed monomer was distilled off under vacuum (˜0.2 Torr) with a receiving flask cooled to −78° C. (dry ice/acetone). After the polymer solid disappeared (about 6 h), the vacuum was turned off, and the cold bath was removed. As the flask was warmed to room temperature, a liquid was obtained, which was confirmed to be the recycled, pure monomer (Me)₂TPL by ¹H NMR analysis; 88% isolated yield.

For a thin film of c-P3T(Me)₂P (Mₙ=2.23 MDa, Ð=1.34; cut into small pieces with scissors): To a 25 mL bottle with a stir bar was added NaOH (42 mg, 3 wt %) and c-P3T(Me)₂P (1.40 g, 12.1 mmol) obtained with a [(Me)₂TPL]:[^{t}Bu-P4] ratio of 6400:1. The mixture was heated at 210° C. (oil bath) and distilled off under vacuum (˜0.2 Torr) with a receiving flask cooled to −78° C. (dry ice/acetone). After the polymer solid disappeared (10 h), the vacuum was turned off, and the cold bath was removed. As the flask was warmed to room temperature, a liquid was obtained, which was confirmed to be the recycled, pure monomer (Me)₂TPL by ¹H NMR analysis; 95% isolated yield.

The recovered (Me)₂TPL monomer was filtered through a layer of silica gel (pentane/acetone=50/1), and the filtrate was concentrated, then added CaH₂ and distilled. The distilled monomer was repolymerized with the same polymerization procedure as the virgin monomer to obtain UHMM c-P3T(Me)₂P with a similar Mₙ (2.09 MDa, Ð=1.39) to that of UHMM c-P3T(Me)₂P synthesized from the staring (Me)₂TPL monomer.

### Example 2. Further Examples of Methods for Producing Cyclic Polymers

Experimental procedures for polymerization of heterocyclic monomers with α,α-dimethyl substituents: (Me)₂TPL, (Me)₂BL, (Me)₂-δ-VL etc. ROP reactions were performed in 10 mL Schlenk flasks or in 5.5 mL glass reactors inside an inert glovebox at ambient temperature (˜23° C.). A predetermined amount of monomers with a, α-dimethyl substituent was added to ^{t}Bu-P4 solution in THF or Toluene. The sealed reactors were taken out of the glove box and stirred at 70° C. or 23° C. as shown in Table 5. After a desired period, a graduate change in viscosity was observed, and an aliquot was taken from the reaction mixture and prepared for ¹H NMR analysis to obtain the percent monomer conversion data. The polymerization was quenched by addition of benzoic acid in chloroform (5 mg/mL), followed by precipitation in excess methanol 2-3 times. All precipitated polymers were then isolated by filtration, and the white polymer solid was dried in a vacuum oven at 60° C. to a constant weight.

TABLE 5
Selected results of ROP of monomers with α,α-dimethyl substituents.

| | | | | Temp. | Time | Conv. | Mₙ ^{c} | Ð ^{c} |
|---|---|---|---|---|---|---|---|---|
| Run ^{a} | Monomer | [M]:[P4] | Solvent | (° C.) | (h) | (%) ^{b} | (kDa) | (M_{w}/Mₙ) |
| 1 | (Me)₂TPL | 6400:1 | THF (5M) | 70 | 10 | 85 | 2226 | 1.34 |
| 2 | (Me)₂BL | 1600:1 | THF (2M) | 70 | 12 | 100 | 169.1 | 1.01 |
| 3 | (Me)₂-δ-VL | 300:1 | Tol. (10M) | 23 | 1 | 100 | 120.5 | 1.32 |
| 4 | (Me)₂-δ-VL | 600:1 | Tol. (10M) | 23 | 6 | 63 | 122.6 | 1.38 |
| 5 | (Me)₂-δ-VL | 1000:1 | Tol. (10M) | 23 | 6 | 38 | 132.3 | 1.27 |

^{a} Conditions: monomer (1.0 mmol).
^{b} Determined by ¹H NMR in CDCl₃.
^{c} Number-average molar mass (Mₙ) and dispersity index (Ð = M_{w}/Mₙ) determined by SEC at 40° C. in CHCl₃ coupled with a DAWN HELEOS II multi (18)-angle light scattering detector and an Optilab TrEX dRI detector for absolute molar mass.

Experimental procedure for polymerization of heterocyclic monomers without α,α-dimethyl substituents: δ-VL, e-CL etc. ROP reactions were performed in 10 mL Schlenk flasks or in 5.5 mL glass reactors inside an inert glovebox at ambient temperature (˜23° C.). A predetermined amount of monomers without α,α-dimethyl substituent in THF. The sealed reactors were taken out of the glove box and stirred at 0° C. for 15 min as shown in Table 6, the ^{t}Bu-P2 solution was added at this temperature. After a desired period, a graduate change in viscosity was observed, and an aliquot was taken from the reaction mixture and prepared for ¹H NMR analysis to obtain the percent monomer conversion data. The polymerization was quenched by addition of benzoic acid in chloroform (5 mg/mL) at 0° C., followed by precipitation in excess methanol 2-3 times. All precipitated polymers were then isolated by filtration, and the white polymer solid was dried in a vacuum oven at 60° C. to a constant weight.

TABLE 6
Selected results of ROP of monomers without α,α-dimethyl substituents.

| | | | | Temp. | Time | Conv. | Mₙ ^{c} | Ð ^{c} |
|---|---|---|---|---|---|---|---|---|
| Run ^{a} | Monomer | Catalyst | [M]:[P₂] | (° C.) | (h) | (%) ^{b} | (kDa) | (M_{w}/Mₙ) |
| 1 | δ-VL | ^{t}Bu-P₂ | 10:1 | 0 | 1 | 100 | 12.6 | 1.33 |
| 2 | CL | ^{t}Bu-P₂ | 10:1 | 0 | 1 | 100 | 7.2 | 1.42 |

^{a} Conditions: monomer (1.0 mmol), THF (0.05 mL).
^{b} Determined by ¹H NMR in CDCl₃.
^{c} Number-average molar mass (Mₙ) and dispersity index (Ð = M_{w}/Mₙ) determined by SEC at 40° C. in CHCl₃ coupled with a DAWN HELEOS II multi (18)-angle light scattering detector and an Optilab TrEX dRI detector for absolute molar mass.

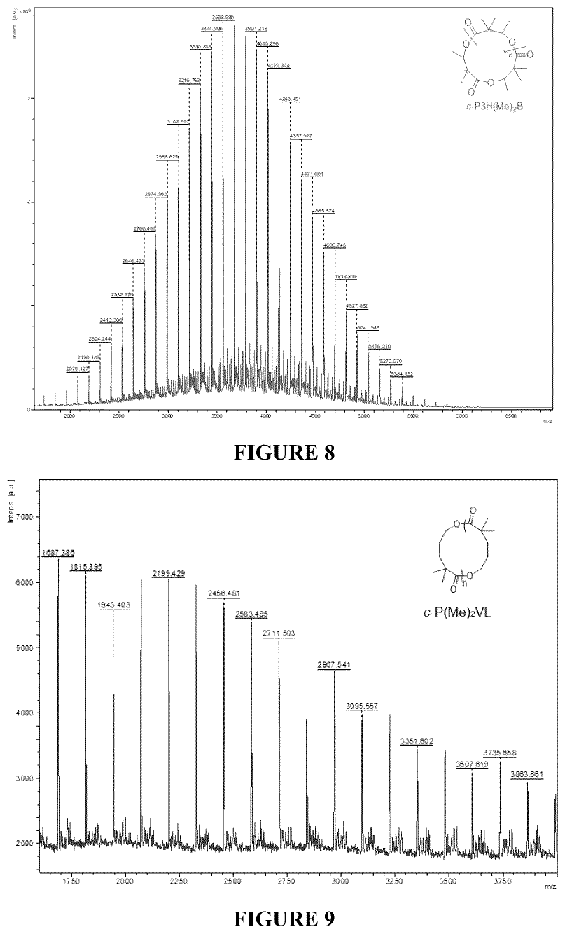

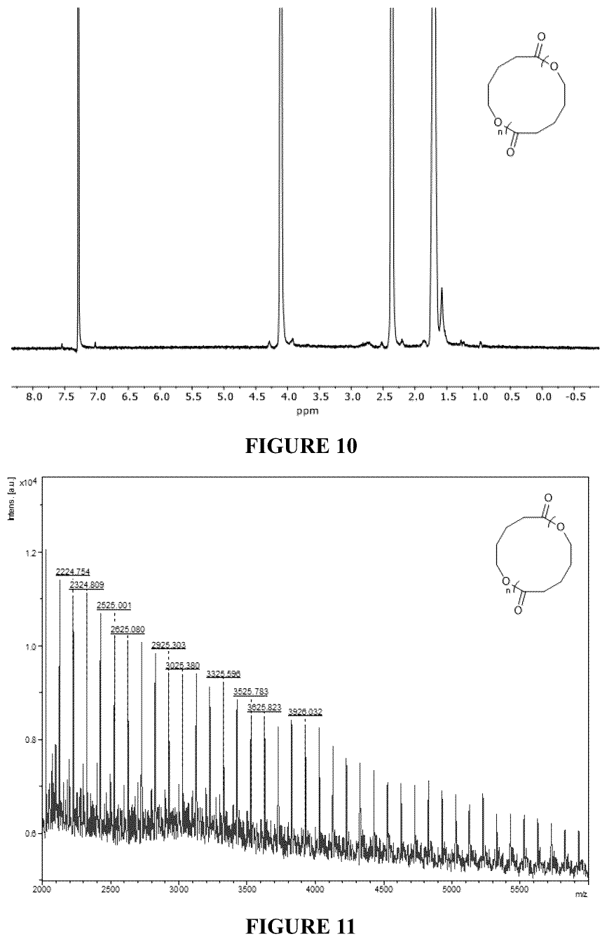

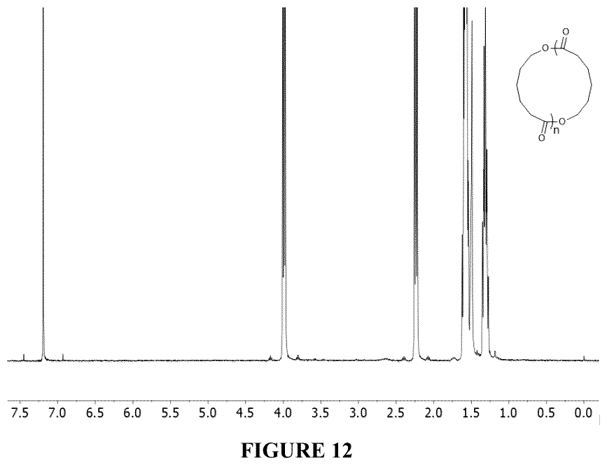

FIGS. 7-12 show examples of characterization of the resulting cyclic polymers formed via these methods.

The compositions, systems, and methods of the appended claims are not limited in scope by the specific compositions, systems, and methods described herein, which are intended as illustrations of a few aspects of the claims. Any compositions, systems, and methods that are functionally equivalent are intended to fall within the scope of the claims. Various modifications of the compositions, systems, and methods in addition to those shown and described herein are intended to fall within the scope of the appended claims. Further, while only certain representative compositions, systems, and method steps disclosed herein are specifically described, other combinations of the compositions, systems, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

What is claimed is:

1. A cyclic polymer defined by Formula I below 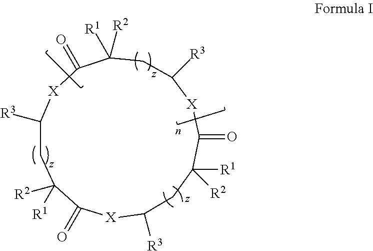
wherein
R¹ and R² are individually hydrogen, C1-C12 alkyl, C2-C12 alkenyl, C2-C12 alkynyl, aryl, or heteroaryl, or R¹ and R² together with the atom to which they are attached form a cycloalkyl ring;
R³ is hydrogen, C1-C12 alkyl, C2-C12 alkenyl, C2-C12 alkynyl, aryl, or heteroaryl;
X is selected from O, S, and NR^{A}, wherein R^{A} is H or C1-C12 alkyl;
z is an integer from 0 to 16; and
n is an integer from 10 to 500,000.

2. The cyclic polymer of claim 1, wherein R¹ and R² are methyl, ethyl, propyl, or butyl, and R³ is hydrogen, methyl, ethyl, propyl, or butyl.

3. The cyclic polymer of claim 1, wherein z is 0, 1 or 2.

4. The cyclic polymer of claim 1, wherein n is an integer from 100 to 500,000, from 100 to 100,000, from 1,000 to 500,000, from 1,000 to 100,000, from 5,000 to 500,000, or from 5,000 to 100,000.

5. The cyclic polymer of claim 1, wherein the polymer comprises a cyclic block copolymer, such as a cyclic block copolymer defined by Formula II below 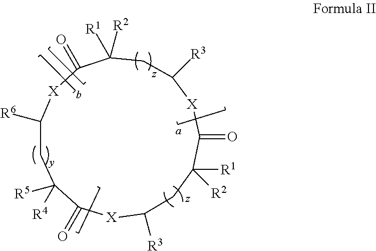
wherein
X is selected from O, S, and NR^{A}, wherein R^{A} is H or C1-C12 alkyl;
R¹ and R² are individually hydrogen, C1-C12 alkyl, C2-C12 alkenyl, C2-C12 alkynyl, aryl, or heteroaryl, or R¹ and R² together with the atom to which they are attached form a cycloalkyl ring;
R³ is hydrogen, C1-C12 alkyl, C2-C12 alkenyl, C2-C12 alkynyl, aryl, or heteroaryl;
R⁴ and R⁵ are individually hydrogen, C1-C12 alkyl, C2-C12 alkenyl, C2-C12 alkynyl, aryl, or heteroaryl, or R⁴ and R⁵ together with the atom to which they are attached form a cycloalkyl ring;
R⁶ is hydrogen, C1-C12 alkyl, C2-C12 alkenyl, C2-C12 alkynyl, aryl, or heteroaryl;
X is selected from O, S, and NR^{A}, wherein R^{A} is H or C1-C12 alkyl;
y is an integer from 0 to 16;
z is an integer from 0 to 16; and
a is an integer from 5 to 490,000 and b is an integer from 5 to 490,000, wherein the sum of a and b is from 10 to 500,000;
wherein the structure of the repeating units represented by x and y of Formula II are different.

6. The cyclic polymer of claim 5, wherein R¹, R², R⁴, and R⁵ are methyl, ethyl, propyl, or butyl, and R³ and R⁶ are hydrogen, methyl, ethyl, propyl, or butyl.

7. The cyclic polymer of claim 6, wherein y is 0, 1 or 2 and z is 0, 1, or 2.

8. The cyclic polymer of claim 1, wherein the polymer comprises an ultrahigh-molar-mass polymer having a number average molecular weight of at least 2 MDa.

9. The cyclic polymer of claim 1, wherein the polymer exhibits a dispersity (Ð) of 1.4 or less, such as a dispersity of from greater than 1 to 1.4, from 1.1 to 1.4, from 1.2 to 1.4, from greater than 1 to 1.3, from 1.1 to 1.3, from 1.2 to 1.3, from greater that 1 to 1.2, from 1.1 to 1.2, or from greater than 1 to 1.1.

10. A method for preparing a cyclic polymer, the method comprising
ring opening polymerization (ROP) of a monomer of Formula III 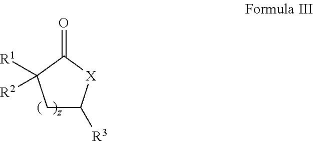
wherein R¹ and R² are individually hydrogen, C1-C12 alkyl, C2-C12 alkenyl, C2-C12 alkynyl, aryl, or heteroaryl, or R¹ and R² together with the atom to which they are attached form a cycloalkyl ring; R³ is hydrogen, C1-C12 alkyl, C2-C12 alkenyl, C2-C12 alkynyl, aryl, or heteroaryl; X is selected from O, S, and NR^{A}, wherein R^{A} is H or C1-C12 alkyl; and
z is an integer from 0 to 16; wherein ROP comprises contacting the monomer of Formula III with a catalyst to form a linear ROP product; and
protic quenching the linear ROP product.

11. The method of claim 10, wherein the catalyst comprises a superbase.

12. The method of claim 10, wherein the catalyst comprises a phosphazene.

13. The method of claim 10, wherein the catalyst comprises one of the following: 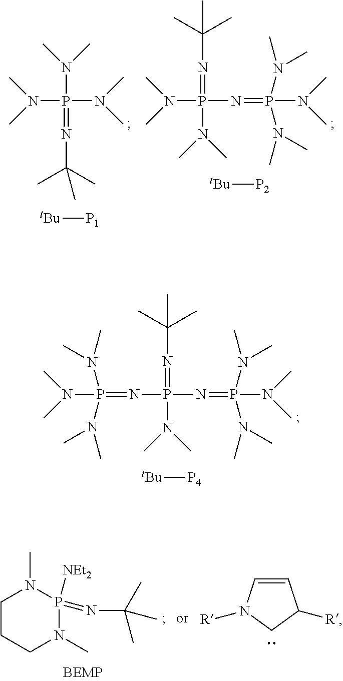
where R′ is alkyl or aryl.

14. The method of claim 13, wherein the catalyst comprises 1-tert-butyl-4,4,4-tris(dimethylamino)-2,2-bis[tris(dimethylamino)-phosphoranylideneamino]-225,425-catenadi (phosphazene) (^{t}Bu-P4).

15. The method of claim 10, wherein protic quenching catalyzes cyclization of the linear ROP product, thereby forming the cyclic polymer.

16. The method of claim 10, wherein protic quenching comprising contacting the linear ROP product with protic solvent, such as an alcohol or an acidified alcohol.

17. The method of claim 10, wherein the monomer of Formula III comprises one of the following:

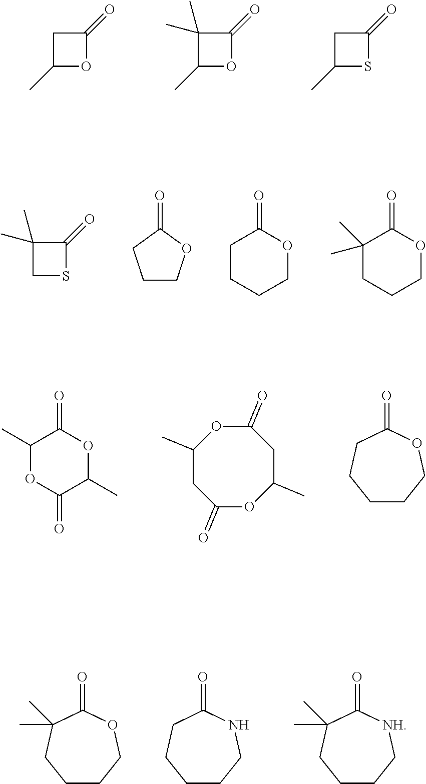

18. The method of claim 10, wherein protic quenching is performed after all of the monomer of Formula III has been polymerized.

19. The method of claim 10, wherein the method is performed as a one-pot process.

20. A method for depolymerizing the cyclic polymer of claim 1, comprising contacting the cyclic polymer with a base, wherein the cyclic polymer is depolymerized to its constituent monomer and conversion to the constituent monomer is 20 wt. % or more.
